(19) United States
(12) Patent Application Publication
(10) Pub. No.: US 2026/0221430 A1
(43) Pub. Date: Jul. 30, 2026

(54) SYSTEMS AND METHODS FOR APPLYING ELECTROLYTES, AND INCREASING WETTABILITY OF ELECTROLYTES AND SEPARATORS

(71) Applicant: 24M Technologies, Inc., Cambridge, MA (US)

(72) Inventors: Aaron David ANESGART, Jamaica Plain, MA (US); Tingfei HUA, Nanjing (CN); Changhao LIU, Waltham, MA (US); Liufeng XIONG, Lexington, MA (US); Xiaoming LIU, Newton, MA (US); Junzheng CHEN, Concord, MA (US); Junhua SONG, Sudbury, MA (US); Anthony D'ANGELO, Medford, MA (US); Michelle Robyn BROUWER, Woburn, MA (US); John CHEN, Quincy, MA (US); Frank Yongzhen FAN, Arlington, MA (US); Dhanya PUTHUSSERI, Millis, MA (US); Grace O'DWYER, Brighton, MA (US)

(21) Appl. No.: 19/460,581

(22) Filed: Jan. 27, 2026

Related U.S. Application Data
(60) Provisional application No. 63/751,150, filed on Jan. 29, 2025.

(51) Int. Cl. H01M 4/38; H01M 4/02; H01M 4/04; H01M 4/1395; H01M 4/62; H01M 50/10; H01M 50/682

(52) U.S. Cl. CPC H01M 4/382; H01M 4/0404; H01M 4/1395; H01M 4/625; H01M 50/10; H01M 50/682; H01M 2004/027

(57) ABSTRACT

Embodiments described herein relate to electrolyte solutions and methods of applying the same. In some aspects, a method can include disposing an electrode material onto a current collector and disposing an electrolyte solution onto the electrode material. The electrolyte solution includes an additive configured to reduce a contact angle that the electrolyte solution forms with the electrode material. Embodiments described herein also relate to an electrochemical cell assembly including an electrochemical cell include a semi-solid cathode material disposed on a cathode current collector, an anode material disposed on an anode current collector, and a separator disposed between the semi-solid mixture and the semi-solid cathode material. An electrolyte reservoir fluidically coupled to the electrochemical cell and configured to communicate an electrolyte to at least the separator.

### CROSS-REFERENCE TO RELATED APPLICATIONS

This application claims priority and benefit of U.S. Provisional Application No. 63/751,150, filed Jan. 29, 2025, and entitled “Systems and Methods for Applying Electrolytes, and Increasing Wettability of Electrolytes and Separators”, the entire disclosure of which is hereby incorporated by reference herein in its entirety.

### TECHNICAL FIELD

Embodiments described herein relate to electrolytes, and systems and methods for application of electrolyte solutions in electrochemical cells.

### BACKGROUND

In the manufacture of electrochemical cells, filling the cells with electrolytes and wetting the separators and electrode materials can be very time-consuming. In some cases, the wetting procedure can take up to 24 hours and significantly contribute to overall battery production time and costs. Diffusivity of the electrolyte solution into the electrode material is often a rate limiting factor in this process. The contrasting miscibility properties of the electrolyte solution, the separator, and the electrode material can lead to inefficient wetting.

Additionally, lithium ions are often consumed during operation and cycling of lithium ion batteries, particularly in batteries with lithium metal anodes. Lithium can be at least partially replenished via the electrolyte. In some electrochemical cells, the electrolyte is incorporated into the cathode as a semi-solid cathode. To address consumption of lithium ion consumption in the lithium metal anode, extra electrolyte can be incorporated into the semi-solid cathode. However, this can make the semi-solid cathode difficult to cast or extrude from casting equipment, as the semi-solid cathode can become too fluid or “soupy” to cast properly. Incorporating extra electrolyte into the semi-solid cathode can also be energetically unfavorable, as ions in the electrolyte would need to travel further to replace ions at the depleted sites of the anode.

### SUMMARY

Embodiments described herein relate generally to electrolyte solutions and methods of applying the same, and electrodes and electrochemical cells that include a supply of electrolyte for replenishment of depleted ions. In some aspects, a method can include disposing an electrode material onto a current collector and disposing an electrolyte solution onto the electrode material. The electrolyte solution includes an additive configured to reduce a contact angle that the electrolyte solution forms with the electrode material. In some embodiments, the additive can include a micelle. In some embodiments, the additive can include a fluorosurfactant such as fluorinated alcohol substituted glycol or perfluorinated alkyl ethoxylates with product names of CAPSTONE® FS-3100, FS-10, FS-30, FS-31, FS-50, or phosphate based compounds, such as trioctyl phosphate (TOP), triethyl phosphate (TEP), and/or tris(2-ethylhexyl) phosphate (TEHP). In some embodiments, disposing the electrolyte solution onto the electrode material is via at least one of stamping, capillary action, inkjet printing, air spray coating, or injection.

In some aspects, a method can include disposing an electrode material onto a current collector, transferring an electrolyte solution from an electrolyte reservoir to an electrolyte nozzle via a capillary channel, and transferring the electrolyte solution from the electrolyte nozzle to the electrode material via an orifice located at a distal end of the electrolyte nozzle. In some embodiments, the electrolyte solution is transferred from the electrolyte reservoir to the capillary channel via gravity driven flow. In some embodiments, the electrolyte solution at least partially fills the electrolyte reservoir to a height that is greater than a height of the electrolyte solution in the electrolyte nozzle.

In some aspects, a method can include disposing an electrode material onto a current collector, infusing a porous medium with an electrolyte solution, and pressing the porous medium onto the electrode material, such that at least a portion of the electrolyte solution is communicated from the porous medium to the electrode material. In some embodiments, the porous medium is disposed at a distal end of stamp and the porous medium is infused with the electrolyte by contacting the porous medium with the electrolyte solution disposed in an electrolyte reservoir. In some embodiments, the porous medium includes porous materials that are compatible with electrolyte

In some embodiments, an electrode includes an electrode material disposed on a current collector, a separator, and a semi-solid mixture disposed between the electrode material and the separator. The semi-solid mixture includes a conductive material and a non-aqueous electrolyte, and can provide lithium ions and solvent for consumption in the electrode material and provide a constant contact surface for wetting of the separator. In some embodiments, the electrode material can include an anode material. In some embodiments, the anode material can include lithium metal. In some embodiments, the conductive material can include KETJEN BLACK® conductive carbon particles, conductive carbon, and/or hard carbon. In some embodiments, the semi-solid mixture can include about 99.9% to about 80% by volume of the non-aqueous electrolyte and about 0.1% to 20% by volume of conductive material. In some embodiments, the non-aqueous electrolyte can include a lithium-containing salt. In some embodiments, the semi-solid mixture does not include an active material.

In some embodiments, an electrochemical cell includes: a semi-solid cathode material disposed on a cathode current collector; an anode material disposed on an anode current collector; a semi-solid mixture disposed on the anode material, the semi-solid mixture including a conductive material and a non-aqueous electrolyte, the semi-solid mixture configured to provide lithium ions and a solvent for consumption in the anode material; and a separator disposed between the semi-solid mixture and the semi-solid cathode material, wherein the semi-solid mixture is configured to provide constant contact for wetting of the separator.

In some embodiments, an electrochemical cell assembly includes: an electrochemical cell including: a semi-solid cathode material disposed on a cathode current collector, an anode material disposed on an anode current collector, and a separator disposed between the semi-solid cathode material and the anode material; and an electrolyte reservoir fluidically coupled to the electrochemical cell, the electrolyte reservoir configured to communicate an electrolyte to at least the separator.

### BRIEF DESCRIPTION OF THE DRAWINGS

FIG. 1 is a visual depiction of contact angle, as described herein.

FIG. 2 is a block diagram of an electrolyte solution, according to an embodiment.

FIG. 3 is a block diagram of an electrolyte dispenser, according to an embodiment.

FIG. 4 is an illustration of an electrolyte dispenser, according to an embodiment.

FIG. 5 is an illustration of an electrolyte dispenser, according to an embodiment.

FIG. 6 is an illustration of an electrolyte dispenser, according to an embodiment.

FIGS. 7A-7D are illustrations of an electrolyte dispenser, and the operation thereof, according to an embodiment.

FIGS. 8A-8C are illustrations of an electrolyte dispenser, according to an embodiment.

FIG. 9 is an illustration of an electrolyte dispenser, according to an embodiment.

FIG. 10 is a flow diagram of a method of applying an electrolyte solution to an electrode material, according to an embodiment.

FIGS. 11A-11C show comparisons of the wetting of an electrode via electrolyte solutions with and without additives.

FIG. 12 shows comparisons of the wetting of uncoated separators and separators coated with additives.

FIG. 13 shows comparisons of the wetting of uncoated separators and separators coated with additives.

FIG. 14 shows comparisons of electrodes before and after the application of electrolyte

FIG. 15 is a block diagram of an electrode with a supply of electrolyte, according to an embodiment.

FIG. 16 is a block diagram of an electrochemical cell with a supply of electrolyte, according to an embodiment.

FIG. 17 is an illustration of an electrode with a supply of electrolyte, according to an embodiment.

FIG. 18 is an illustration of an electrochemical cell with a supply of electrolyte, according to an embodiment.

FIG. 19 is an illustration of an electrochemical cell with a supply of electrolyte, according to an embodiment.

FIG. 20 is an illustration of an electrochemical cell including an electrolyte reservoir, according to an embodiment.

FIGS. 21 and 22 are illustrations of electrochemical cells including an electrolyte reservoir, according to some embodiments.

### DETAILED DESCRIPTION

Embodiments described herein relate to the electrolyte solutions, and their inclusion in electrodes and electrochemical cells, and electrodes and electrochemical cells that include a supply of electrolyte for replenishment of depleted ions.

Several factors can slow the production process of electrochemical cells, including the electrolyte infusion process. Electrolyte solutions can have difficulty wetting electrode materials as well as separators. For example, the hydrophobicity of polyolefin-based separators (such as polyethylene or polypropylene) can slow the diffusion and/or wetting process.

Electrolyte filling and electrolyte wetting are important steps in lithium-ion battery manufacturing. If the electrolyte does not sufficiently fill the pore space of electrodes and wet the active particles, a solid electrolyte interphase (SEI) layer does not grow uniformly on the active particles during the formation cycles. This can lead to electrolyte decomposition during cycling, as well as lower Coulombic efficiency or the seeding of lithium dendrite formation. Also, if pores in the separator and/or electrode material are not sufficiently filled with electrolyte during cell operation, pathways for lithium ion transport can become blocked or closed due to the presence of residual gas phase blocking pore branches. This can lead to decreased effective conductivity of lithium ions in the pore structure and larger overpotential losses, negatively affecting performance and safety. Additionally, blocked transport paths can lead to non-homogeneous lithium concentrations within the electrochemical cell and non-uniform current densities through the electrochemical cell.

Embodiments described herein improve the electrolyte wetting process, for example, by including electrolyte additives that promote electrolyte wetting in electrolytes, modifying separators with improved hydrophilicity, and/or enhancing electrolyte application methods, and combinations thereof. Lithium ion battery manufacturing processes have commonly included electrolyte injection for filling the batteries with electrolyte. The wetting of electrodes and separators is dependent on the diffusion of electrolyte from outside to the center of the electrode stack or jelly roll form factor. Large electrode size, hydrophobicity of separators, and large numbers of electrode/separator interfaces are all factors that can slow the wetting process. The wetting is time-intensive and costly, therefore reducing the electrolyte wetting time and complexity can reduce costs and improve performance.

Several production processes have incorporated a vacuum into the production process. Additionally, increased temperatures have been explored for improving wetting. While these have improved the wetting process and the efficiency of the overall production process, the wetting remains as a rate limiting step of the overall electrochemical cell production process. This slowness is exacerbated in large format cells having large length-to-thickness and/or width-to-thickness ratios. Large format cells are of particular importance in the electric vehicle industry.

Some embodiments described herein include electrolyte application methods that uniformly apply electrolyte to a full electrode area, in contrast to conventional electrolyte injection, in which electrolyte is injected into a pouch or a hard case. The direct contact between each electrode and electrolyte solution shortens the diffusion length for electrolyte to infiltrate the electrode pores. This shortens the wetting time. Electrolyte application methods described herein can include dripping, electrolyte spraying, inkjet printing, stamping, dispensing via a capillary nozzle, or any other suitable method or combinations thereof.

Some embodiments described herein include electrolyte additives that reduce the surface energy of the electrolyte solution and reduce the contact angle between the electrolyte and the electrode. In some embodiments, these additives can include a fluorosurfactant, (e.g., fluorinated alcohol substituted glycol or perfluorinated alkyl ethoxylates, such as FS-3100 (polyethylene oxide, mono(3,3,4,4,5,5,6,6,7,7,8,8,8-tridecafluorooctyl) ether), FS-10(3,3,4,4,5,5,6,6,7,7,8,8,8-Tridecafluorooctanesulphonic acid), FS-30(Partially Fluorinated Alcohol Substituted Glycol/Polyethylene glycol), FS-31(Partially Fluorinated Alcohol Substituted Glycol), FS-50(Betaine partially fluorinated surfactant), or phosphate based compounds such as trioctyl phosphate (TOP), triethyl phosphate (TEP), or tris(2-ethylhexyl) phosphate (TEHP).

In addition, during operation and cycling of lithium ion electrochemical cells, lithium ions are often consumed continuously. In other words, lithium ions migrate to locations (e.g., in a conductive matrix) where their recovery is thermodynamically unfavorable. This phenomenon is particularly prevalent in electrochemical cells with lithium metal anodes. Electrochemical cells with semi-solid cathodes can include a lower total volume electrolyte solution than electrochemical cells with conventional (i.e., solid) cathodes. Examples of electrochemical cells with semi-solid cathodes can be found in U.S. Pat. No. 8,993,159 (“the '159 patent”), filed Apr. 29, 2013, entitled “Semi-Solid Electrodes Having High Rate Capability,” the disclosure of which is hereby incorporated by reference in its entirety.

Extra electrolyte solution can be added to semi-solid cathodes to modify the overall makeup of the semi-solid cathodes. A semi-solid cathode with a high electrolyte content can provide electrolyte to wet a separator and replenish depleted electrolyte of the electrochemical cell. However, providing an appropriate amount of electrolyte to the semi-solid cathode to deplete the consumed lithium ions in the anode can result in a semi-solid cathode with very low loading (i.e., high electrolyte to active/conductive material ratio). Such a semi-solid cathode material can be difficult to cast from casting equipment (e.g., casting nozzles), due to the semi-solid cathode material being too fluid or “soupy” to cast properly. Other examples of casting equipment are described in U.S. Patent publication no. 2020/0014025 (“the '025 publication”), filed Jul. 9, 2019, entitled, “Continuous and Semi-Continuous Methods of Semi-Solid Electrode and Battery Manufacturing,” the disclosure of which is hereby incorporated by reference in its entirety.

By placing an electrolyte-containing material in contact with the anode, the depletion of the ions, solvents, and/or electrolyte from the anode can be actively combatted without making the semi-solid cathode uncastable. Replenishing the ions and/or solvents in the anode via an electrolyte-containing material in contact with the anode can improve the performance of the electrochemical cell. For example, ion replenishment can extend lithium cycle life and stabilize the electrochemical cell's internal resistance significantly.

In some embodiments, electrodes described herein can be semi-solid electrodes. In comparison to conventional electrodes, semi-solid electrodes can be made: (i) thicker (e.g., greater than about 150 μm-up to about 2,000 μm or even greater) due to the reduced tortuosity and higher electronic conductivity of semi-solid electrodes, (ii) with higher loadings of active materials, (iii) with a simplified manufacturing process utilizing less equipment, and (iv) can be operated between a wide range of C-rates while maintaining a substantial portion of their theoretical charge capacity. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein, are binderless and/or do not use binders that are used in conventional battery manufacturing. Instead, the volume of the electrode normally occupied by binders in conventional electrodes, is now occupied, by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes.

Since the semi-solid electrodes described herein can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein. The use of semi-solid, and in some embodiments, binderless electrodes can also be beneficial in the incorporation of an overcharge protection mechanism, as generated gas can migrate to the electrode/current collector interface without binder particles inhibiting the movement of the gas within the electrode.

In some embodiments, the electrode materials described herein can be a flowable semi-solid or condensed liquid composition. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in a liquid electrolyte to produce a semi-solid electrode. Examples of electrochemical cells that include a semi-solid and/or binderless electrode material are described in the '159 patent.

In some embodiments, the electrode materials described herein can be a flowable semi-solid or condensed liquid composition. In some embodiments, a flowable semi-solid electrode can include a suspension of an electrochemically active material (anodic or cathodic particles or particulates), and optionally an electronically conductive material (e.g., carbon) in a non-aqueous liquid electrolyte. In some embodiments, the active electrode particles and conductive particles can be co-suspended in an electrolyte to produce a semi-solid electrode. In some embodiments, electrode materials described herein can include conventional electrode materials (e.g., including lithium metal).

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

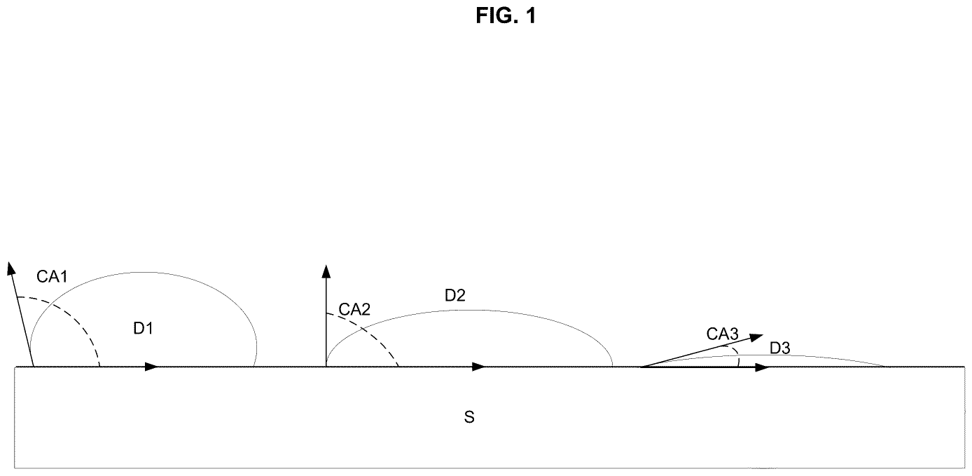

The contact angle of the electrolyte with the electrode or separator can be a quantitative measure of the wettability of the electrolyte on said surfaces. As used herein, “contact angle” refers to an angle formed between a line drawn tangentially to a droplet of liquid on a surface and a line drawn tangent to the surface, on which the droplet of liquid rests, as illustrated in FIG. 1. Contact angle is a function of fluid properties (e.g., viscosity, surface tension), as well as the miscibility between the surface material and the liquid. As shown in FIG. 1, droplet D1 forms a contact angle CA1 with a surface S of greater than 90°. Droplet D2 forms a contact angle CA2 with the surface S of about 90°. Droplet D3 forms a contact angle CA3 with the surface S of less than 90°. Liquids and surfaces with differing miscibility (e.g., water on a hydrophobic surface) often form contact angles greater than 90°, while liquids and surfaces with similar miscibility (e.g., water on a hydrophilic surface) often form contact angles less than 90°.

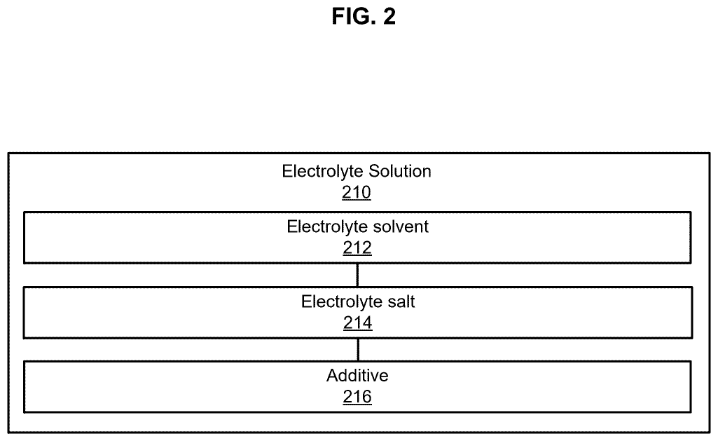

FIG. 2 is a block diagram of an electrolyte solution 210, according to an embodiment. As shown, the electrolyte solution 210 includes an electrolyte solvent 212, an electrolyte salt 214, and an additive 216. The electrolyte salt 214 is dissolved in the electrolyte solvent 212, such that the electrolyte salt 214 can conduct ions through the electrolyte solution 210 and any electrode material that the electrolyte solution 210 contacts. The additive 216 is dissolved in the electrolyte solvent 212 to improve the wettability of the electrolyte solution 210.

In some embodiments, the electrolyte solvent 212 can include a polar solvent. In some embodiments, the polar solvent can include 1,2-dimethoxyethane, bis-(2-fluoro-ethyl)-ether, 1,2-diethoxyethane, bis(2-methoxyethyl) ether, triethylene glycol dimethyl ether, tetraethylene glycol dimethyl ether, diethyl ether, dipropyl ether, 1,2-dipropoxyethane, dibutoxyethane, 1,2-diethoxypropane, dimethyl carbonate, 1,3-dioxolane, 1,4-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, fluoroethylene carbonate, tetrahydropyran, 4-vinyl-1,3-dioxolan-2-one, dimethyl sulfone, methyl butyrate, ethyl propionate, trimethyl phosphate, triethyl phosphate, gamma-butyrolactone, 4-methylene-1,3-dioxolan-2-one, methylene ethylene carbonate, 4,5-dimethylene-1,3-dioxolan-2-one, allyl ether, triallyl amine, triallyl cyanurate, triallyl isocyanurate, water, carbonate, dimethyl carbonate, 1,3-dioxolane, ethyl methyl carbonate, diethyl carbonate, dimethyl sulfoxide, ethyl vinyl sulfone, tetramethylene sulfone, ethyl methyl sulfone, ethylene carbonate, vinylene carbonate, and/or fluoroethylene carbonate.

In some embodiments, the electrolyte solvent 212 can include a non-polar solvent. In some embodiments, the non-polar solvent can include fluoroether, fluorobutane, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, methoxynonafluorobutane, ethoxynonafluorobutane, 2,2,2-trifluoroethyl nonafluorobutanessulfonate, 1,1,2,2-tetrafluoroethyl-2,2,3,3-tetrafluoropropyl ether, bis(2,2,2-trifluoroethyl) ether, 1,1,2,2,-tetrafluoroethyl-2,2,2-trifluoroethyl ether, tris(2,2,2-trifluoroethyl)orthoformate, pentafluoroethyl 2,2,2-trifluoroethyl ether, 2,2,3,3,4,4,5,5-octafluoro-1-pentanol, 3,3,4,4,5,5-hexafluorotetrahydropyran, or any combination thereof.

In some embodiments, the electrolyte solvent 212 can make up at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, at least about 28 wt %, at least about 29 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %. at least about 40 wt %, at least about 41 wt %, at least about 42 wt %, at least about 43 wt %, at least about 44 wt %, at least about 45 wt %, at least about 46 wt %, at least about 47 wt %, at least about 48 wt %, at least about 49 wt %, at least about 50 wt %, at least about 51 wt %, at least about 52 wt %, at least about 53 wt %, at least about 54 wt %, at least about 55 wt %, at least about 56 wt %, at least about 57 wt %, at least about 58 wt %, at least about 59 wt %, at least about 60 wt %, at least about 61 wt %, at least about 62 wt %, at least about 63 wt %, at least about 64 wt %, at least about 65 wt %, at least about 66 wt %, at least about 67 wt %, at least about 68 wt %, or at least about 69 wt % of the electrolyte solution 210. In some embodiments, the electrolyte solvent 212 can make up no more than about 70 wt %, no more than about 69 wt %, no more than about 68 wt %, no more than about 67 wt %, no more than about 66 wt %, no more than about 65 wt %, no more than about 64 wt %, no more than about 63 wt %, no more than about 62 wt %, no more than about 61 wt %, no more than about 60 wt %, no more than about 59 wt %, no more than about 58 wt %, no more than about 57 wt %, no more than about 56 wt %, no more than about 55 wt %, no more than about 54 wt %, no more than about 53 wt %, no more than about 52 wt %, no more than about 51 wt %, no more than about 50 wt %, no more than about 49 wt %, no more than about 48 wt %, no more than about 47 wt %, no more than about 46 wt %, no more than about 45 wt %, no more than about 44 wt %, no more than about 43 wt %, no more than about 42 wt %, no more than about 41 wt %, no more than about 40 wt %, no more than about 39 wt %, no more than about 38 wt %, no more than about 37 wt %, no more than about 36 wt %, no more than about 35 wt %, no more than about 34 wt %, no more than about 33 wt %, no more than about 32 wt %, no more than about 31 wt %, no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt %, no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, or no more than about 11 wt % of the electrolyte solution 210. Combinations of the above-referenced weight percentages are also possible (e.g., at least about 10 wt % and no more than about 70 wt % or at least about 13 wt % and no more than about 39 wt %), inclusive of all values and ranges therebetween. In some embodiments, the electrolyte solvent 212 can make up about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, about 50 wt %, about 51 wt %, about 52 wt %, about 53 wt %, about 54 wt %, about 55 wt %, about 56 wt %, about 57 wt %, about 58 wt %, about 59 wt %, about 60 wt %, about 61 wt %, about 62 wt %, about 63 wt %, about 64 wt %, about 65 wt %, about 66 wt %, about 67 wt %, about 68 wt %, about 69 wt %, or about 70 wt % of the electrolyte solution 210.

In some embodiments, the electrolyte salt 214 can include bis(fluorosulfonyl)imide ions (e.g., LiFSI, or NaFSI). In some embodiments, the electrolyte salt 214 can include lithium bis(fluorosulfonyl)imide (LiFSI). In some embodiments, the electrolyte salt 214 can include sodium bis(fluorosulfonyl)imide (NaFSI). In some embodiments, the electrolyte salt 214 can be absent of bis(fluorosulfonyl)imide ions. In some embodiments, the electrolyte salt 214 can include lithium bis(fluorosulfonyl)imide (F₂LiNO₄S₂), lithium bis(trifluoromethylsulfonyl)imide (LiC₂F₆NO₄S₂), lithium bis(oxalato)borate, lithium hexafluorophosphate (LiPF₆), lithium hexafluoroarsenate (LiAsF₆), lithium bis(trifluoromethane) sulfonimide (LiN(SO₂CF₃)₂), lithium trifluoromethanesulfonate (LiCF₃SO₃), lithium perchlorate (LiClO₄), lithium difluoro oxalato borate (LiBF₂(C₂O₄)), lithium iodide (LiI), lithium bromide (LiBr), lithium chloride (LiCl), lithium hydroxide (LiOH), lithium nitrate (LiNO₃), lithium 2-trifluoromethyl-4,5-dicyanoimidazole (LiTDI), lithium sulfate (Li₂SO₄), lithium tetrafluoroborate (LiBF₄), lithium difluorophosphate (LiPO₂F₂), any other suitable first additive or any suitable combination thereof.

In some embodiments, the electrolyte salt 214 can make up at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt %, at least about 26 wt %, at least about 27 wt %, 28 wt %, at least about 29 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 41 wt %, at least about 42 wt %, at least about 43 wt %, at least about 44 wt %, at least about 45 wt %, at least about 46 wt %, at least about 47 wt %, at least about 48 wt %, or at least about 49 wt % of the electrolyte solution 210. In some embodiments, the electrolyte salt 214 can make up no more than about 50 wt %, no more than about 49 wt %, no more than about 48 wt %, no more than about 47 wt %, no more than about 46 wt %, no more than about 45 wt %, no more than about 44 wt %, no more than about 43 wt %, no more than about 42 wt %, no more than about 41 wt %, no more than about 40 wt %, no more than about 39 wt %, no more than about 38 wt %, no more than about 37 wt %, no more than about 36 wt %, no more than about 35 wt %, no more than about 34 wt %, no more than about 33 wt %, no more than about 32 wt %, no more than about 31 wt %, no more than about 30 wt %, no more than about 29 wt %, no more than about 28 wt %, no more than about 27 wt %, no more than about 26 wt %, no more than about 25 wt %, no more than about 24 wt %, no more than about 23 wt %, no more than about 22 wt % no more than about 21 wt %, no more than about 20 wt %, no more than about 19 wt %, no more than about 18 wt %, no more than about 17 wt %, no more than about 16 wt %, no more than about 15 wt %, no more than about 14 wt %, no more than about 13 wt %, no more than about 12 wt %, or no more than about 11 wt % of the electrolyte solution 210. Combinations of the above-referenced weight percentages are also possible (e.g., at least about 10 wt % and no more than about 50 wt % or at least about 28 wt % and no more than about 43 wt %), inclusive of all values and ranges therebetween. In some embodiments, the electrolyte salt 114 can make up about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 26 wt %, about 27 wt %, about 28 wt %, about 29 wt %, about 30 wt %, about 31 wt %, about 32 wt %, about 33 wt %, about 34 wt %, about 35 wt %, about 36 wt %, about 37 wt %, about 38 wt %, about 39 wt %, about 40 wt %, about 41 wt %, about 42 wt %, about 43 wt %, about 44 wt %, about 45 wt %, about 46 wt %, about 47 wt %, about 48 wt %, about 49 wt %, or about 50 wt % of the electrolyte solution 210.

In some embodiments, the additive 216 can include a micelle. In some embodiments, the additive 216 can include a fluorosurfactant, such as a fluorinated alcohol substituted glycol or perfluorinated alkyl ethoxylates with product names of CAPSTONE® FS-3100, FS-10, FS-30, FS-31, FS-50, or phosphate based compounds, such as trioctyl phosphate (TOP), triethyl phosphate (TEP), and tris(2-ethylhexyl) phosphate (TEHP).

In some embodiments, the additive 216 can make up at least about 0.01 wt %, at least about 0.02 wt %, at least about 0.03 wt %, at least about 0.04 wt %, at least about 0.05 wt %, at least about 0.06 wt %, at least about 0.07 wt %, at least about 0.08 wt %, at least about 0.09 wt %, at least about 0.1 wt %, at least about 0.2 wt %, at least about 0.3 wt %, at least about 0.4 wt %, at least about 0.5 wt %, at least about 0.6 wt %, at least about 0.7 wt %, at least about 0.8 wt %, at least about 0.9 wt %, at least about 1 wt %, at least about 2 wt %, at least about 3 wt %, at least about 4 wt %, at least about 5 wt %, at least about 6 wt %, at least about 7 wt %, at least about 8 wt %, or at least about 9 wt % of the electrolyte solution 210. In some embodiments, the additive 216 can make up no more than about 10 wt %, no more than about 9 wt %, no more than about 8 wt %, no more than about 7 wt %, no more than about 6 wt %, no more than about 5 wt %, no more than about 4 wt %, no more than about 3 wt %, no more than about 2 wt %, no more than about 1 wt %, no more than about 0.9 wt %, no more than about 0.8 wt %, no more than about 0.7 wt %, no more than about 0.6 wt %, no more than about 0.5 wt %, no more than about 0.4 wt %, no more than about 0.3 wt %, no more than about 0.2 wt %, no more than about 0.1 wt %, no more than about 0.09 wt %, no more than about 0.08 wt %, no more than about 0.07 wt %, no more than about 0.06 wt %, no more than about 0.05 wt %, no more than about 0.04 wt %, no more than about 0.03 wt %, or no more than about 0.02 wt % of the electrolyte solution 210. Combinations of the above-referenced weight percentages are also possible (e.g., at least about 0.01 wt % and no more than about 10 wt % or at least about 0.2 wt % and no more than about 1 wt %), inclusive of all values and ranges therebetween. In some embodiments, the additive 216 can make up about 0.01 wt %, about 0.02 wt %, about 0.03 wt %, about 0.04 wt %, about 0.05 wt %, about 0.06 wt %, about 0.07 wt %, about 0.08 wt %, about 0.09 wt %, about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1 wt %, about 2 wt %, about 3 wt %, about 4 wt %, about 5 wt %, about 6 wt %, about 7 wt %, about 8 wt %, about 9 wt %, or about 10 wt % of the electrolyte solution 210.

In some embodiments, the inclusion of the additive 216 in the electrolyte may cause the electrolyte solution 210 (e.g., a droplet of the electrolyte solution) to have a contact angle on an electrode surface in a range of about 0 degrees to about 90 degrees.

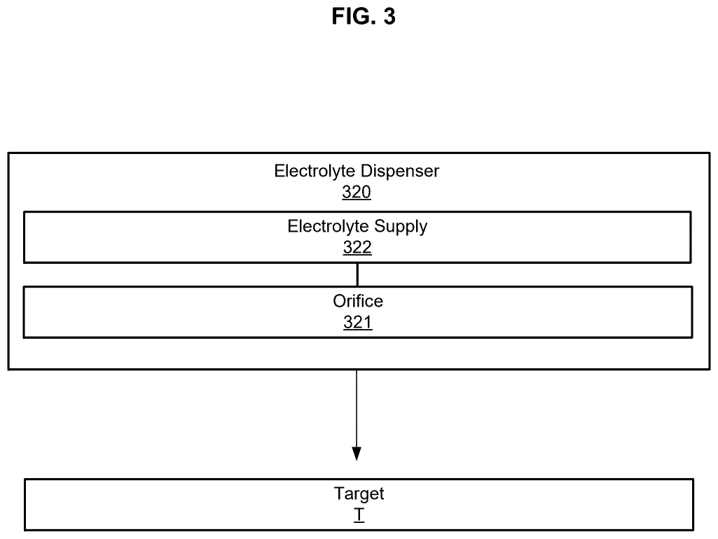

FIG. 3 is a block diagram of an electrolyte dispenser 320, according to an embodiment. As shown, the electrolyte dispenser 320 includes an orifice 321 and an electrolyte supply 322. In some embodiments, the electrolyte dispenser 320 can include an electrolyte injector, an air sprayer, an ultrasonic sprayer, an inkjet printer, a stamping apparatus, a dripping device, a capillary delivery mechanism, a gravity flow dispenser, a pump, or any other suitable delivery mechanism or combinations thereof.

In use, electrolyte solution is conveyed to a target T via the orifice 321. In some embodiments, the target T can include an electrode material. In some embodiments, the target T can include a separator. In some embodiments, the target T can include a separator disposed on an electrode material. In some embodiments, the separator can include a coating disposed thereon to improve wettability of the electrolyte solution. In some embodiments, the coating can include a ceramic coating (e.g., Al₂O₃, AlOOH, SiO₂, ZrO₂) and/or a polymer coating (e.g., polyvinylidene fluoride (PVDF), polyethylene oxide (PEO)).

In some embodiments, the target T can include an electrode disposed on a current collector. In some embodiments, the target T can include a semi-solid electrode. In some embodiments, the target T can include a conventional solid electrode. In some embodiments, the target T can be placed on a conveyor and conveyed below, above, or to the side of the electrolyte dispenser 320. In some embodiments, the electrode material and/or the current collector material can be placed upon a pouch material (e.g., polypropylene, and/or polyethylene, and/or polyester). In some embodiments, the target T can include an electrode to be included in a large format electrochemical cell (i.e., the electrode has a large length-to-thickness and/or width-to-thickness ratio).

In some embodiments, the target T can include an electrode with a length-to-thickness ratio and/or a width-to-thickness ratio of at least about 100, at least about 200, at least about 300, at least about 400, at least about 500, at least about 600, at least about 700, at least about 800, at least about 900, at least about 1,000, at least about 2,000, at least about 3,000, at least about 4,000, at least about 5,000, at least about 6,000, at least about 7,000, at least about 8,000, at least about 9,000, at least about 10,000, at least about 20,000, at least about 30,000, at least about 40,000, at least about 50,000, at least about 60,000, at least about 70,000, at least about 80,000, at least about 90,000, at least about 100,000, at least about 200,000, at least about 300,000, at least about 400,000, at least about 500,000, at least about 600,000, at least about 700,000, at least about 800,000, at least about 900,000, or at least about 1,000,000, inclusive of all values and ranges therebetween. In some embodiments, the target T can include an electrode with a length and/or a width of at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, at least about 90 cm, at least about 1 m, at least about 2 m, at least about 3 m, at least about 4 m, at least about 5 m, at least about 6 m, at least about 7 m, at least about 8 m, at least about 9 m, at least about 10 m, at least about 20 m, at least about 30 m, at least about 40 m, at least about 50 m, at least about 60 m, at least about 70 m, at least about 80 m, at least about 90 m, or at least about 100 m.

Electrolyte solution passes through the orifice 321 to wet the target T. In some embodiments, the orifice 321 can have a circular shape, an elliptical shape, a square shape, a rectangular shape, and/or any other suitable form factor. In some embodiments, the orifice 321 can have a diameter or cross-sectional width of at least about 5 μm, at least about 6 μm, at least about 7 μm, at least about 8 μm, at least about 9 μm, at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, or at least about 9 mm. In some embodiments, the orifice 321 can have a diameter or width of no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 100 μm, no more than about 90 μm, no more than about 80 μm, no more than about 70 μm, no more than about 60 μm, no more than about 50 μm, no more than about 40 μm, no more than about 30 μm, no more than about 20 μm, no more than about 10 μm, no more than about 9 μm, no more than about 8 μm, no more than about 7 μm, or no more than about 6 μm. Combinations of the above-referenced diameters/widths are also possible (e.g., at least about 5 μm and no more than about 1 cm or at least about 50 μm and no more than about 1 mm), inclusive of all values and ranges therebetween. In some embodiments, the orifice 321 can have a diameter or width of about 5 μm, about 6 μm, about 7 μm, about 8 μm, about 9 μm, about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, or about 10 mm.

In some embodiments, electrolyte solution can be temporarily stopped from passing through the orifice 321 via surface tension. In some embodiments, electrolyte solution can reach the orifice 321 via wicking or capillary action. In some embodiments, electrolyte solution can be pumped through the orifice 321. In some embodiments, the orifice 321 can include an adjustable covering that blocks the flow of electrolyte solution therethrough. In some embodiments, the orifice 321 can be toggled open or closed (e.g., via blocking implement). In some embodiments, the opening size of the orifice 321 can be adjustable.

The electrolyte supply 322 provides electrolyte solution to the orifice 321. The electrolyte supply 322 is fluidically coupled to the orifice 321. In some embodiments, the electrolyte supply 322 can be fluidically coupled to the orifice 321 via a conduit, for example, a channel or tube. In some embodiments, flow through the conduit can be via gravity. In some embodiments, flow through the conduit can be via wicking or capillary action. In some embodiments, flow through the conduit can be induced via pumping (e.g., positive pressure pumping or vacuum pumping).

In some embodiments, the electrolyte supply 322 can have a volume of at least about 1 mL, at least about 5 mL, at least about 10 mL, at least about 50 mL, at least about 100 mL, at least about 500 mL, at least about 1 L, at least about 5 L, at least about 10 L, at least about 50 L, at least about 100 L, at least about 500 L, at least about 1 m³, at least about 5 m³, at least about 10 m³, at least about 50 m³, at least about 100 m³, or at least about 500 m³. In some embodiments, the electrolyte supply 322 can have a volume of no more than about 1,000 m³, no more than about 500 m³, no more than about 100 m³, no more than about 50 m³, no more than about 10 m³, no more than about 5 m³, no more than about 1 m³, no more than about 500 L, no more than about 100 L, no more than about 50 L, no more than about 10 L, no more than about 5 L, no more than about 1 L, no more than about 500 mL, no more than about 100 mL, no more than about 50 mL, no more than about 10 mL, or no more than about 5 mL. Combinations of the above-referenced volumes are also possible (e.g., at least about 1 mL and no more than about 1,000 m³ or at least about 100 mL and no more than about 10 m³), inclusive of all values and ranges therebetween. In some embodiments, the electrolyte supply 322 can have a volume of about 1 mL, about 5 mL, about 10 mL, about 50 mL, about 100 mL, about 500 mL, about 1 L, about 5 L, about 10 L, about 50 L, about 100 L, about 500 L, about 1 m³, about 5 m³, about 10 m³, about 50 m³, about 100 m³, about 500 m³, or about 1,000 m³.

In some embodiments, the target T can be conveyed or moved relative to the electrolyte dispenser 320 to expose a large portion of the target T to the electrolyte dispenser 320. In some embodiments, the target T can be stationary. In some embodiments, the electrolyte dispenser 320 can be conveyed. In some embodiments, the electrolyte dispenser 320 can be stationary. In some embodiments, the target T can be conveyed while the electrolyte dispenser 320 is stationary. In some embodiments, the electrolyte dispenser 320 can be conveyed while the target T is stationary. In some embodiments, the electrolyte dispenser 320 and the target T can be conveyed at different velocities. In some embodiments, a vacuum can be applied to the environment surrounding the target T while the electrolyte solution is conveyed onto the target T. In some embodiments, heat can be applied to the target T while the electrolyte solution is conveyed onto the target T.

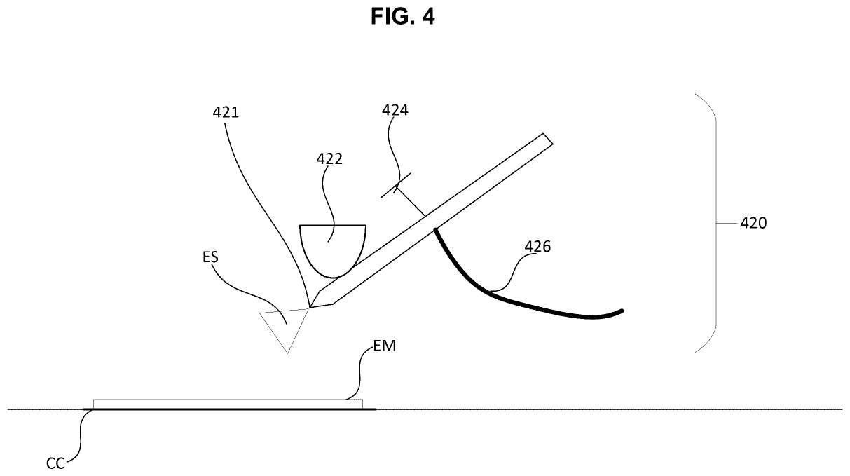

FIG. 4 is an illustration of an electrolyte dispenser 420, according to an embodiment. As shown, the electrolyte dispenser 420 includes an orifice 421, an electrolyte supply 422, an airflow regulator 424 (e.g., a dial, knob etc.), and a gas conduit 426. As shown, the electrolyte dispenser 420 is conveying electrolyte solution ES onto an electrode material EM placed upon a current collector CC. In some embodiments, the orifice 421 and the electrolyte supply 422 can be the same or substantially similar to the orifice 321 and the electrolyte supply 322, as described above with reference to FIG. 3. Thus, certain aspects of the orifice 421, and the electrolyte supply 422 are not described in greater detail herein.

As shown, the electrolyte dispenser 420 includes a spraying mechanism, for example, a gas sprayer. The electrolyte solution ES is atomized as it passes through the orifice 421. The electrolyte supply 422 is fluidically coupled to the body of the electrolyte dispenser 420 and the orifice 421. In some embodiments, the electrolyte dispenser 420 can include a reservoir or a volume therein, through which the electrolyte solution ES moves before it is expelled through the orifice 421.

In use, gas (e.g., air or an inert gas such as nitrogen) is delivered through the gas conduit 426 from a gas supply (not shown) to induce movement and dispensation of the electrolyte solution ES through the conduit 426. The gas is delivered in a pressurized state. In some embodiments, the gas can include air. In some embodiments, the gas can include N₂, argon, or any other suitable inert gas or combinations thereof. In some embodiments, the electrolyte solution ES is held in place in the orifice 421 (e.g., via surface tension), until pressured to exit the electrolyte dispenser 420 via pressure from the gas. In some embodiments, the gas can be pressurized to about 0.1 bar (gauge), about 0.2 bar, about 0.3 bar, about 0.4 bar, about 0.5 bar, about 0.6 bar, about 0.7 bar, about 0.8 bar, about 0.9 bar, about 1 bar, about 2 bar, about 3 bar, about 4 bar, about 5 bar, about 6 bar, about 7 bar, about 8 bar, about 9 bar, about 10 bar, about 20 bar, about 30 bar, about 40 bar, about 50 bar, about 60 bar, about 70 bar, about 80 bar, about 90 bar, or about 100 bar, inclusive of all values and ranges therebetween.

The airflow regulator 424 regulates flow of gas into the body of the electrolyte dispenser 420. Greater gas flow can produce larger dispensation rates of the electrolyte solution ES. As shown, the electrolyte solution ES is disposed onto the electrolyte material. In some embodiments, the electrolyte solution ES can be disposed onto a separator and/or any of the other items included in the target T, as described above with reference to FIG. 3.

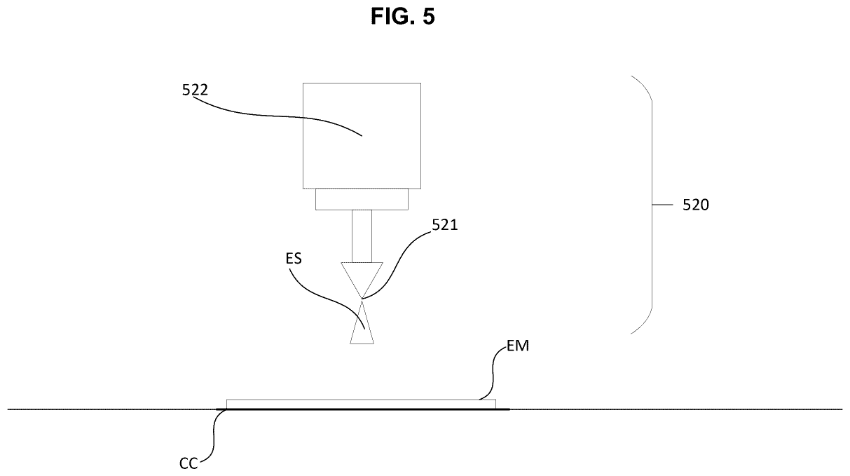

FIG. 5 is an illustration of an electrolyte dispenser 520, according to an embodiment. As shown, the electrolyte dispenser 520 includes an orifice 521 through which electrolyte solution ES is expelled to contact electrode material EM disposed on a current collector CC and an electrolyte supply 522. In some embodiments, the orifice 521 and the electrolyte supply 522 can be the same or substantially similar to the orifice 421 and the electrolyte supply 422, as described above with reference to FIG. 4. Thus, certain aspects of the orifice 521 and the electrolyte supply 522 are not described in greater detail herein.

The electrolyte dispenser 520 uses ultrasonic stimulation to expel and apply the electrolyte solution ES. Ultrasonic vibrations are used to create a fine mist of droplets of electrolyte solution ES. These droplets are applied to the electrode material EM and/or a separator (not shown). In some embodiments, the ultrasonic energy can be applied consistently. In some embodiments, the ultrasonic energy can be applied in pulses. The ultrasonic electrolyte dispenser 520 may beneficially allow generation of the electrolyte spray without use of a gas, thereby reducing evaporation and loss of electrolyte, and/or inhibiting side reactions that may occur due to interaction of the gas (e.g., air) with the electrode. In addition, the ultrasonic electrolyte dispenser 520 may generate finer electrolyte particles that may infuse faster into the target T.

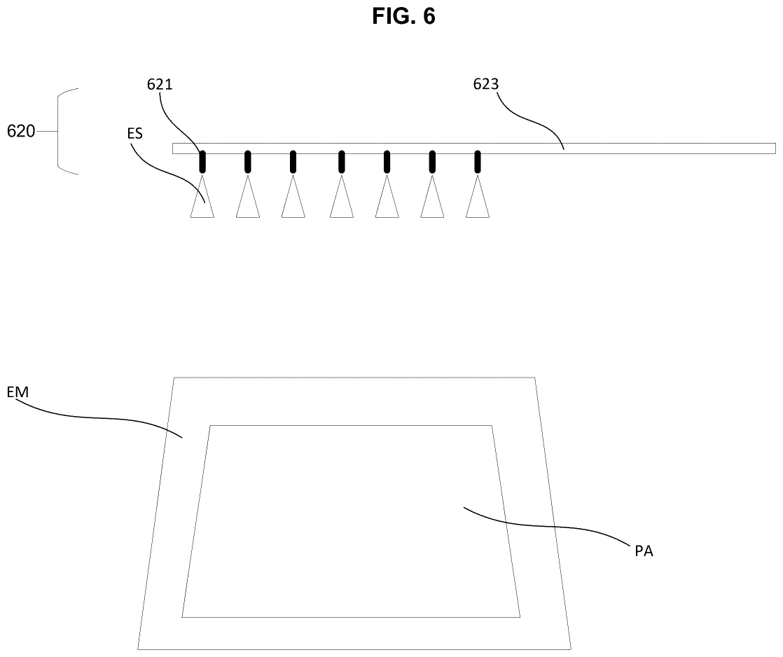

FIG. 6 is an illustration of an electrolyte dispenser 620, according to an embodiment. As shown, the electrolyte dispenser 620 includes a series of orifices 621 and a conduit 623. The conduit 623 is fluidically coupled to the orifices 621 and an electrolyte supply (not shown). In some embodiments, the orifices 621 can be the same or substantially similar to the orifice 521. Thus, certain aspects of the orifices 621 are not described in greater detail herein.

As shown, the conduit 623 and the orifices 621 form a printer head to spray small droplets of an electrolyte solution ES onto an electrode material EM. The sprayed electrolyte solution ES covers a printed area PA of the electrode material EM. As shown, the printed area PA includes less than the entire top surface of the electrode material EM. In some embodiments, the printed area PA can include at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% of the top surface of the electrode material EM. In some embodiments, the printed area PA can include no more than about 100%, no more than about 99%, no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, or no more than about 15%. Combinations of the above-referenced percentages are also possible (e.g., at least about 10% and no more than about 99% or at least about 50% and no more than about 80%), inclusive of all values and ranges therebetween. In some embodiments, the printed area PA can include about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 99%, or about 100% of the top surface of the electrode material EM.

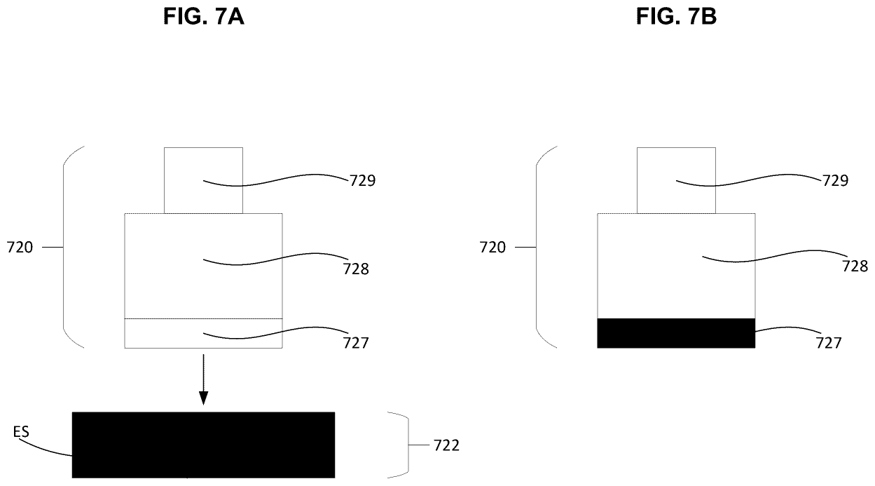

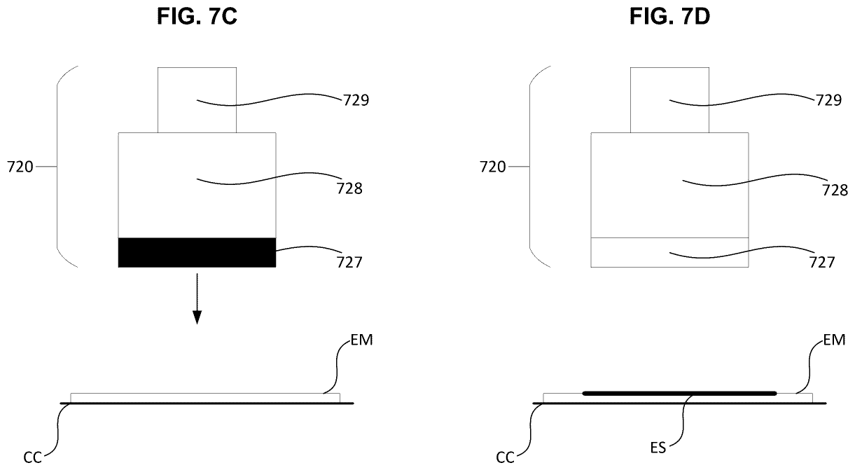

FIGS. 7A-7D are illustrations of an electrolyte dispenser 720, and the operation thereof, according to an embodiment. The electrolyte dispenser 720 acts as a stamping apparatus. As shown, the electrolyte dispenser 720 includes an electrolyte supply 722, a porous material 727, a flat plate 728, and a handle 729. In some embodiments, the electrolyte supply 722 can be the same or substantially similar to the electrolyte supply 522, as described above with reference to FIG. 5. Thus, certain aspects of the electrolyte supply 522 are not described in greater detail herein.

In use, the porous material 727 is contacted with the electrolyte supply 722 (see FIG. 7A), such that an amount of electrolyte solution ES saturates the porous material 727 (see FIG. 7B). The porous material 727 is then pressed onto an electrode material EM disposed on a current collector CC (see FIG. 7C), where electrolyte solution ES is expelled onto the electrode material EM (see FIG. 7D).

The porous material 727 absorbs an electrolyte solution ES and dispenses the electrolyte solution ES upon being pressed. In some embodiments, the porous material 727 can include or be formed from a cloth. In some embodiments, the porous material 727 can include or be formed from a polymer (e.g., polyethylene, polypropylene, ethylene propylene diene terpolymer (EPDM)). In some embodiments, the porous material 727 can include or be formed from a foam. In some embodiments, the porous material 727 can include or be formed from a polymer foam. In some embodiments, the porous material 727 can include or be formed from cotton, linen, denim, nylon, twill, bamboo, wool, polyester, spongin, carbon cloth, polyurethane, cellulose, calcium carbonate, silica, polyethylene, polypropylene, or any combination thereof. The porous material 727 is compressible. In some embodiments, the porous material can include a brush. The porous material 727 may be selected to be stable in electrolyte. If the porous material 727 is inorganic, it may be compressible and have sufficient mechanical strength, such that the porous material 727 stays intact during processing.

When the porous material 727 is brought in contact with the electrolyte solution ES, the electrolyte solution ES infuses into pores of the porous material 727, for example, due to capillary action or negative pressure (e.g., the porous material 727 can be compressed before contacting the electrolyte solution ES, and then allowed to expand which generates a negative pressure within the pores thereof causing the electrolyte solution ES to be absorbed or infused therewithin). When the porous material 727 is contacted with and pressed on the electrode material EM as shown in FIG. 7C, the decrease in volume of the porous material 727 due to compression causes at least a portion of the electrolyte solution ES to be effused, released, or discharged from the porous material ES onto the electrode material EM as shown in FIG. 7D, and thereby, transferred to the electrode material EM. The electrolyte solution ES may then absorb or be infused into the electrode material EM.

In some embodiments, the porous material 727 can have a porosity of at least about 10%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, or at least about 75%. In some embodiments, the porous material 727 can have a porosity of no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, or no more than about 15%. Combinations of the above-referenced porosities are also possible (e.g., at least about 10% and no more than about 80% or at least about 30% and no more than about 70%), inclusive of all values and ranges therebetween. In some embodiments, the porous material 727 can have a porosity of about 10%, about 15%, about 20%, about 25%, about 30%, about 35%, about 40%, about 45%, about 50%, about 55%, about 60%, about 65%, about 70%, about 75%, or about 80%.

In some embodiments, the porous material 727 can have a thickness of at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, or at least about 9 cm. In some embodiments, the porous material 727 can have a thickness of no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced thicknesses are also possible (e.g., at least about 10 μm and no more than about 10 cm or at least about 100 μm and no more than about 5 mm), inclusive of all values and ranges therebetween. In some embodiments, the porous material 727 can have a thickness of about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, or about 10 cm.

In some embodiments, the handle 729 can be machined. In some embodiments, the handle 729 can be configured to be manually operated by a user. In some embodiments, the handle 729 can be configured to be held and operated by a machine, for example, by a robotic manipulator. The flat plate 728 is an optional feature and provides additional structural integrity to the electrolyte dispenser. In some embodiments, the flat plate 728 can act as a rigid body, to which the porous material 727 is coupled so as to provide a rigid backing for facilitating compression and pressing of the porous material 727 on the target.

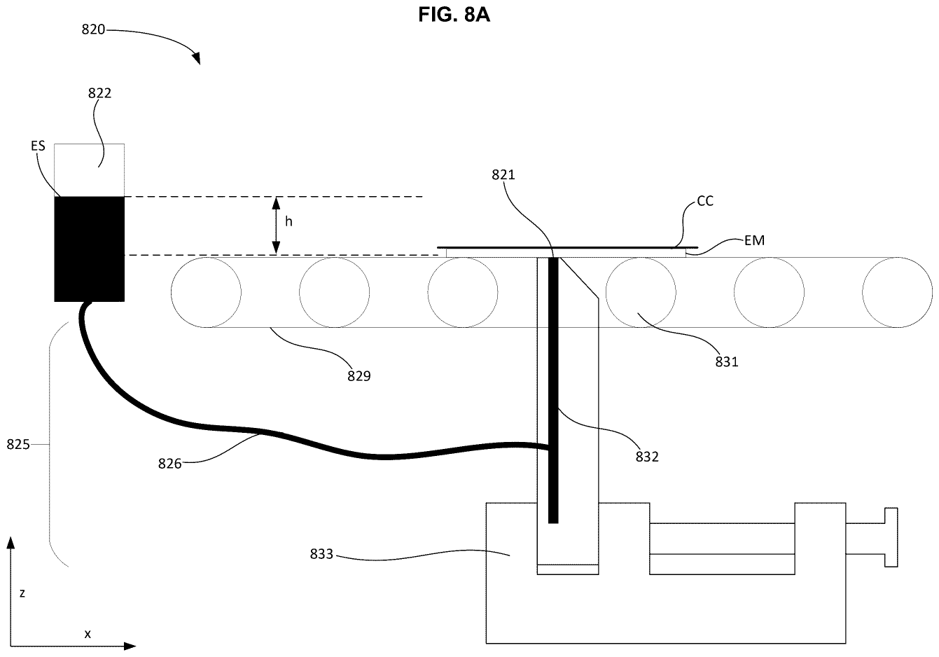

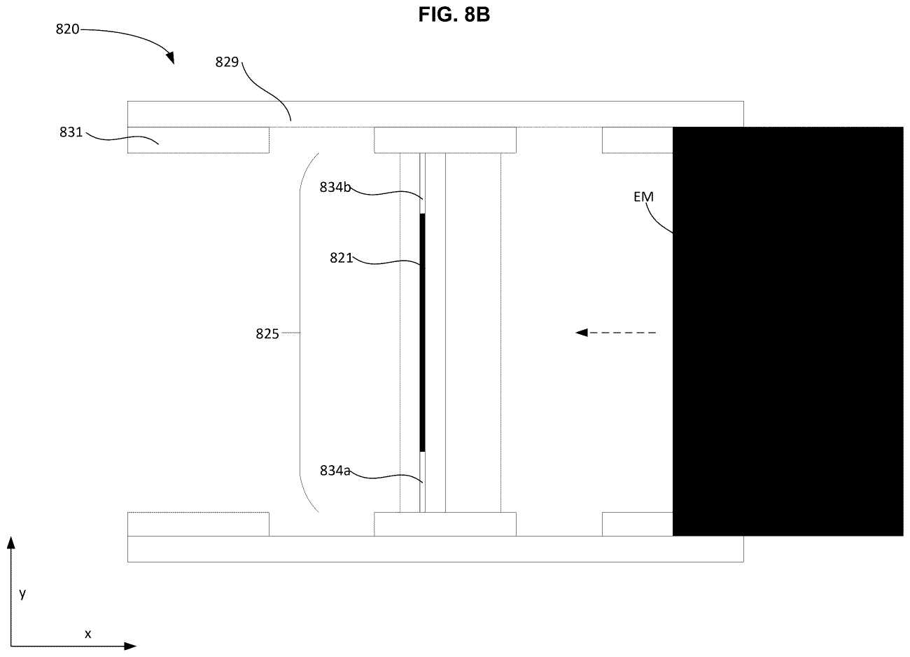

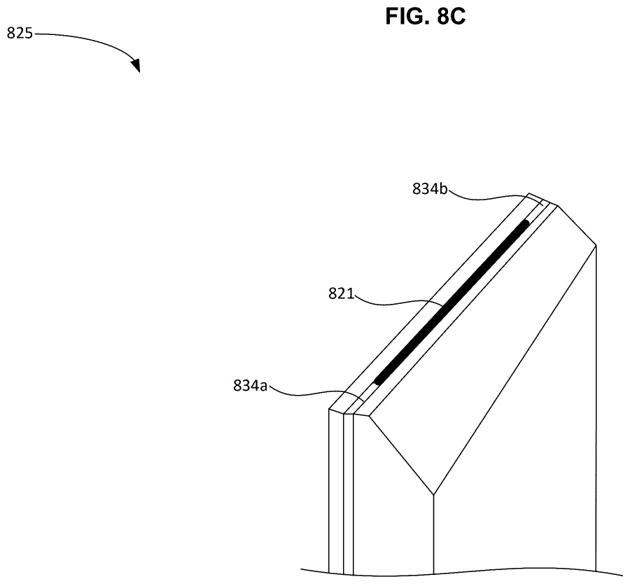

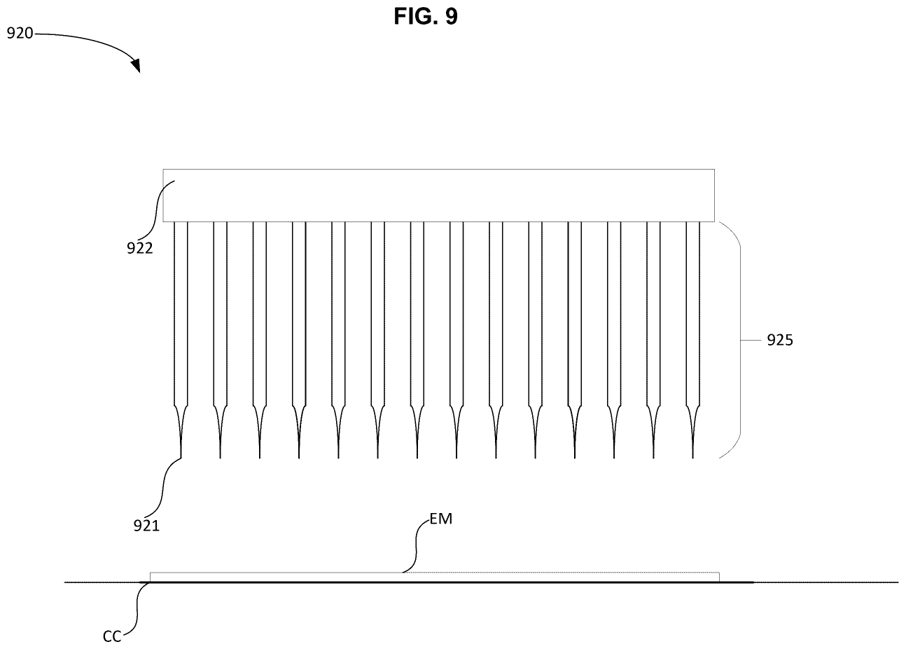

FIGS. 8A-8C are illustrations of an electrolyte dispenser 820, according to an embodiment. As shown, the electrolyte dispenser 820 includes an orifice 821, an electrolyte supply 822, a nozzle 825, a conduit 826, a frame member 829, rollers 831, an electrolyte reservoir 832, a clamp 833, and shims 834a, 834b. In some embodiments, the orifice 821, the electrolyte supply 822, and the conduit 826 can be the same or substantially similar to the orifice 421, the electrolyte supply 422, and the conduit 426, as described above with reference to FIG. 4. Thus, certain aspects of the orifice 821, the electrolyte supply 822, and the conduit 826 are not described in greater detail herein. FIG. 8A shows a side profile view of the electrolyte dispenser 820, FIG. 8B shows an overhead view of the electrolyte dispenser 820, and FIG. 8C shows a side perspective view of a portion of the nozzle 825. Axes are shown in FIGS. 8A-8B for structural clarity.

As shown, the orifice 821 has a rectangular shape. In some embodiments, the orifice 821 can have an elliptical shape, a square shape, a circular shape, or any other suitable shape. In some embodiments, a distance across the orifice 821 (i.e., a width of the orifice 821) can be at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, or at least about 9 mm. In some embodiments, the distance across the orifice 821 can be no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced distances are also possible (e.g., at least about 10 μm and no more than about 1 cm or at least about 50 μm and no more than about 2 mm), inclusive of all values and ranges therebetween. In some embodiments, the distance across the orifice 821 can be about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, or about 10 mm. In some embodiments, the distance across the orifice 821 may be selected to cause the electrolyte solution ES to be drawn through the orifice 821 and communicated to the nozzle 825 via capillary action, and thus communicated to the electrode material EM via capillary driven flow.

As shown, the electrolyte supply 822 includes a container having an electrolyte solution ES filled therein up to an electrolyte level. In order to provide fluidic head to the electrolyte solution ES, the electrolyte level can be higher than the dispensation site (i.e., the orifice 821) by a height h. This allows a net head loss in the electrolyte solution ES, such that the electrolyte solution ES can be freely dispensed through the orifice 821 assisted by gravity, i.e., communicated at least partially via gravity driven flow (e.g., in addition to capillary driven flow provided by the orifice 821). In some embodiments, the height h can be at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, or at least about 90 cm. In some embodiments, the height h can be no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced heights h are also possible (e.g., at least about 1 mm and no more than about 1 m or at least about 1 cm and no more than about 10 cm), inclusive of all values and ranges therebetween. In some embodiments, the height h can be about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, or about 1 m.

As shown, the nozzle 825 is fluidically coupled to the electrolyte supply 822 via the conduit 826. More specifically, the reservoir 832 inside the nozzle 825 is fluidically coupled to the electrolyte supply 822 via the conduit 826. From the head provided via the height h of the electrolyte solution ES in the electrolyte supply 822, the electrolyte solution ES can be dispensed from the reservoir 832 upward via the orifice 821 onto electrode material EM due to gravity driven flow. As shown, the electrode material EM is coupled to a current collector CC. In some embodiments, the current collector CC can be absent from the components conveyed. In some embodiments, the electrolyte solution ES can be dispensed onto a separator (not shown). In use, the frame member 829, for example, a conveyor belt, chain, or pallets (e.g., vacuum pallets) provides structural support and secures the rollers 831 in place. The rollers 831 can be fastened to the frame member 829 while still having rotational freedom of motion. The electrode material EM rolls on top of the rollers 831, such that the electrode material EM contacts electrolyte solution ES being expelled from the orifice 821. As shown, the nozzle 825 is placed between two of the rollers 831. In some embodiments, the rollers 831 can be automated, such that they rotate at a desired rotational velocity, inducing a desired translational velocity of the electrode material EM. The clamp 833 can hold the nozzle 825 in place, preventing unwanted deflection either in the vertical direction or the horizontal direction. In some embodiments, a continuous roll of the electrode material EM may be conveyed on the frame member 829 via the rollers 839 to allow continuous infusion of the electrolyte solution ES via the electrolyte dispenser 820.

FIG. 8B shows an overhead view of the electrolyte dispenser 820, with the electrode material EM rolling over the rollers 831. The rollers 831 are held in place via the framing members. FIG. 8C shows a more detailed view of the nozzle 825. As shown, the nozzle 825 may include shims 834a, 834b that have a thickness configured to regulate, adjust the opening width of the nozzle 825 (i.e., the distance across the orifice 821), or cause the nozzle 825 to have a desired opening width. In some embodiments, the shims 834a, 834b can have a thickness of at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 2 mm, at least about 3 mm, at least about 4 mm, at least about 5 mm, at least about 6 mm, at least about 7 mm, at least about 8 mm, or at least about 9 mm. In some embodiments, the shims 834 a, 834 b can have a thickness of no more than about 1 cm, no more than about 9 mm, no more than about 8 mm, no more than about 7 mm, no more than about 6 mm, no more than about 5 mm, no more than about 4 mm, no more than about 3 mm, no more than about 2 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced thicknesses are also possible (e.g., at least about 10 μm and no more than about 1 cm or at least about 50 μm and no more than about 2 mm), inclusive of all values and ranges therebetween. In some embodiments, the thickness of the shims 834 a, 834 b can be about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 2 mm, about 3 mm, about 4 mm, about 5 mm, about 6 mm, about 7 mm, about 8 mm, about 9 mm, or about 10 mm. In some embodiments, the shims 834a, 834b may include screws that can screwed in or out to adjust a spacing between opposite surfaces defining the nozzle 825 to adjust a distance across the orifice 821 and/or the nozzle 825.

In some embodiments, a wick can be included in the electrolyte dispenser 820 to control the speed of electrolyte dispensation. In some embodiments, the application of the electrolyte solution ES can be adjusted by adjusting the size of the shims 834a, 834b. In some embodiments, the shims 834a, 834b can include a polymer, a metal, polyethylene, polypropylene, or any other suitable material or combinations thereof. In some embodiments, the surface tension of the electrolyte solution ES can inhibit unwanted dispensation, such that the orifice 821 acts as a capillary. The continuous movement of the electrode material EM can allow constant flow of the electrolyte solution ES via the orifice, as the electrolyte solution ES is consistently consumed by the electrode material EM passing by and contacting the electrolyte solution ES. In some embodiments, the nozzle 825 can include a blocker (not shown) disposed on the orifice 821. The blocker can be activated to inhibit flow of electrolyte through the orifice 821.

FIG. 9 is an illustration of an electrolyte dispenser 920, according to an embodiment. As shown, the electrolyte dispenser 920 includes pipettes 925 with orifices 921 and an electrolyte supply 922. In some embodiments, the orifices 921 and the electrolyte supply 922 can be the same or substantially similar to the orifice 421 and the electrolyte supply 422, as described above with reference to FIG. 4. Thus, certain aspects of the orifices 921 and the electrolyte supply 922 are not described in greater detail herein.

As shown, an array of pipettes 925 is arranged, such that the pipettes 925 dispense electrolyte solution onto electrode material EM, which is coupled to a current collector CC. In some embodiments, the pipettes 925 can dispense electrolyte solution onto a separator (not shown). In some embodiments, the electrolyte solution can be pumped into the pipettes 925 from the electrolyte supply 922. In some embodiments, the movement of the pipettes 925 can dispense electrolyte solution to the surface of the electrode material EM. In some embodiments, the amount of electrolyte applied to the electrode surface can be controlled by the gap between the pipettes, the pumping speed, and/or the moving speed of the pipettes 925 relative to the electrode material EM. In some embodiments, the pipettes 925 can move while the electrode material EM is stationary. In some embodiments, the electrode material EM can move while the pipettes 925 are stationary.

As shown, the electrolyte dispenser 920 includes 14 pipettes 925. In some embodiments, the electrolyte dispenser 920 can include at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, or at least about 900 pipettes 925. In some embodiments, the electrolyte dispenser 920 can include no more than about 1,000, no more than about 900, no more than about 800, no more than about 700, no more than about 600, no more than about 500, no more than about 400, no more than about 300, no more than about 200, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2 pipettes 925. Combinations of the above-referenced numbers of pipettes 925 are also possible (e.g., at least about 1 and no more than about 1,000 or at least about 10 and no more than about 100), inclusive of all values and ranges therebetween. In some embodiments, the electrolyte dispenser 920 can include about 1, about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, or about 1,000 pipettes 925. As shown, the pipettes 925 are arranged in a single-file line. In some embodiments, the pipettes 925 can be arranged in a 2-dimensional array (e.g., a 4×4 array).

In some embodiments, the pipettes 925 can be separated by a spacing of at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, or at least about 90 cm. In some embodiments, the pipettes 925 can be separated by a spacing of no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced spacing distances are also possible (e.g., at least about 1 mm and no more than about 1 m or at least about 1 cm and no more than about 10 cm), inclusive of all values and ranges therebetween. In some embodiments, the pipettes 925 can be separated by a spacing of about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, or about 1 m.

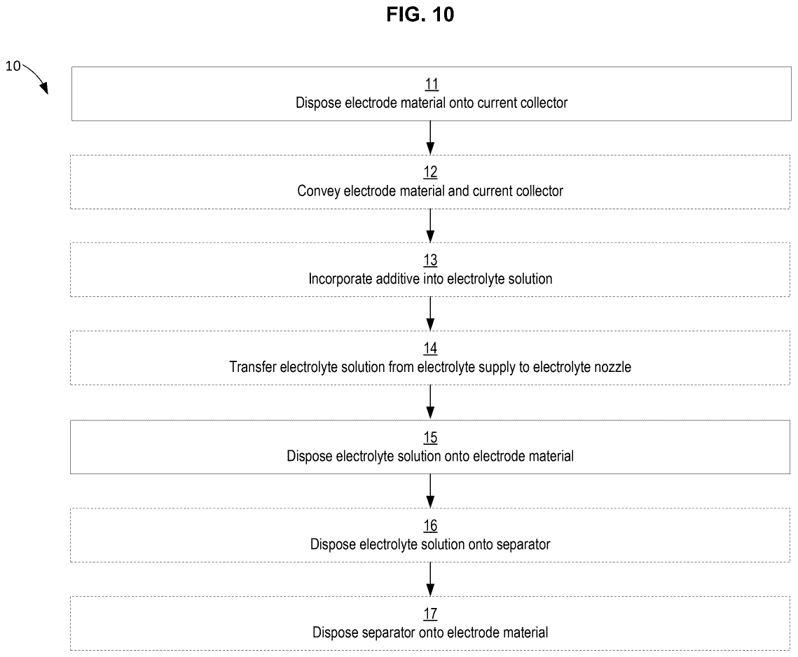

FIG. 10 is a flow diagram of a method 10 of applying an electrolyte solution to an electrolyte material, according to an embodiment. As shown, the method 10 includes disposing an electrode material onto a current collector at step 11. The method 10 optionally includes conveying the electrode material and the current collector at step 12, incorporating an additive into the electrolyte solution at step 13, and transferring the electrolyte solution from an electrolyte supply to the electrolyte nozzle at step 14. The method 10 includes disposing an electrolyte solution onto the electrolyte material at step 15. The method 10 optionally includes disposing the electrolyte solution onto the separator at step 16 and disposing the separator onto the electrode material at step 17. While described as steps occurring in a particular order, this is for illustrative purposes only and any of the steps described with reference to the method 10 can occur simultaneously, sequentially, or in any other suitable order.

Step 11 includes disposing an electrode material onto a current collector. In some embodiments, the current collector can instead be disposed onto the electrode material. In some embodiments, the electrode material can include a semi-solid electrode material. In some embodiments, the electrode material can include a conventional solid electrode material. In some embodiments, the electrode material can include an anode material. In some embodiments, the electrode material can include a cathode material.

Step 12 is optional and includes conveying the electrode material and the current collector. In some embodiments, the electrode material and the current collector are conveyed or displaced while the electrolyte dispenser is stationary. In some embodiments, the electrode material and the current collector are stationary while the electrolyte dispenser is conveyed or displaced. In some embodiments, both the electrode material and the current collector can be conveyed or displaced relative to each other while the electrolyte dispenser is conveyed at a different speed.

Step 13 is optional and includes incorporating an additive into an electrolyte solution. The additive can improve the wettability of the electrolyte solution. In some embodiments, the additive can include a micelle. In some embodiments, the additive can include a fluorosurfactant, such as a fluorinated alcohol substituted glycol or perfluorinated alkyl ethoxylates with product names of CAPSTONE® FS-3100, FS-10, FS-30, FS-31, FS-50, or phosphate based compounds such as trioctyl phosphate (TOP), triethyl phosphate (TEP), and/or tris(2-ethylhexyl) phosphate (TEHP).

Step 14 is optional and includes transferring an electrolyte solution from an electrolyte supply to an electrolyte nozzle. In some embodiments, the transferring of the electrolyte solution can be via a conduit, for example, a capillary channel under capillary flow. In some embodiments, transferring the electrolyte solution from the electrolyte supply to the electrolyte nozzle can be via a pump. In some embodiments, transferring the electrolyte solution from the electrolyte supply to the electrolyte nozzle can be via gravity.

Step 15 includes disposing the electrolyte solution onto the electrode material. In some embodiments, the disposing can be via dripping, spraying, ultrasonic spraying, stamping, capillary action, inkjet printing, air spray coating, or injection. In some embodiments, the additive(s) included in the electrolyte solution can improve the wettability, such that the application of the electrolyte solution to the electrode material exhibits improved wetting.

In some embodiments, the inclusion of the additive in the electrolyte solution can reduce the contact angle the electrolyte solution forms with the electrode material. In some embodiments, the contact angle the electrolyte solution forms with the electrode material can be at least about 0°, at least about 5°, at least about 10°, at least about 15°, at least about 20°, at least about 25°, at least about 30°, at least about 35°, at least about 40°, at least about 45°, at least about 50°, at least about 55°, at least about 60°, at least about 65°, at least about 70°, at least about 75°, at least about 80°, or at least about 85°. In some embodiments, the contact angle the electrolyte solution forms with the electrode material can be no more than about 90°, no more than about 85°, no more than about 80°, no more than about 75°, no more than about 70°, no more than about 65°, no more than about 60°, no more than about 55°, no more than about 50°, no more than about 45°, no more than about 40°, no more than about 35°, no more than about 30°, no more than about 25°, no more than about 20°, no more than about 15°, no more than about 10°, or no more than about 5°. Combinations of the above-referenced angles are also possible (e.g., at least about 0°and no more than about 90°or at least about 10°and no more than about 40°), inclusive of all values and ranges therebetween. In some embodiments, the contact angle the electrolyte solution forms with the electrode material can be about 0°, about 5°, about 10°, about 15°, about 20°, about 25°, about 30°, about 35°, about 40°, about 45°, about 50°, about 55°, about 60°, about 65°, about 70°, about 75°, about 80°, about 85°, or about 90°.

Step 16 is optional and includes disposing the electrolyte solution onto a separator. In some embodiments, step 16 can be executed in lieu of step 15. In other words, the method 10 can include wetting a separator and not an electrode material. In some embodiments, the separator can include a coating disposed thereon to improve the wettability of the separator. In some embodiments, the separator coating can include a ceramic, a polymer, Al₂O₃, AlOOH, SiO₂, and/or ZrO₂.

In some embodiments, the thickness of the coating on the separator can be at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, or at least about 900 μm. In some embodiments, the thickness of the coating on the separator can be no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm. Combinations of the above-referenced thicknesses are also possible (e.g., at least about 10 μm and no more than about 1 mm or at least about 40 μm and no more than about 200 μm), inclusive of all values and ranges therebetween. In some embodiments, the thickness of the coating on the separator can be about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, or about 1 mm.

In some embodiments, the coating on the separator can reduce the contact angle the electrolyte solution forms with the separator. In some embodiments, the contact angle the electrolyte solution forms with the separator can be at least about 0°, at least about 5°, at least about 10°, at least about 15°, at least about 20°, at least about 25°, at least about 30°, at least about 35°, at least about 40°, at least about 45°, at least about 50°, at least about 55°, at least about 60°, at least about 65°, at least about 70°, at least about 75°, at least about 80°, or at least about 85°. In some embodiments, the contact angle the electrolyte solution forms with the separator can be no more than about 90°, no more than about 85°, no more than about 80°, no more than about 75°, no more than about 70°, no more than about 65°, no more than about 60°, no more than about 55°, no more than about 50°, no more than about 45°, no more than about 40°, no more than about 35°, no more than about 30°, no more than about 25°, no more than about 20°, no more than about 15°, no more than about 10°, or no more than about 5°. Combinations of the above-referenced angles are also possible (e.g., at least about 0° and no more than about 90° or at least about 10° and no more than about 40°), inclusive of all values and ranges therebetween. In some embodiments, the contact angle the electrolyte solution forms with the separator can be about 0°, about 5°, about 10°, about 15°, about 20°, about 25°, about 30°, about 35°, about 40°, about 45°, about 50°, about 55°, about 60°, about 65°, about 70°, about 75°, about 80°, about 85°, or about 90°.

Step 17 is optional and includes disposing the separator onto the electrode material. In some embodiments, both the separator and the electrode material can have electrolyte solution applied thereto before the electrode material and the separator are combined in step 17. In some embodiments, the separator can be coupled to the electrode material before disposing the electrolyte solution onto the separator. In other words, step 17 can occur before step 16.

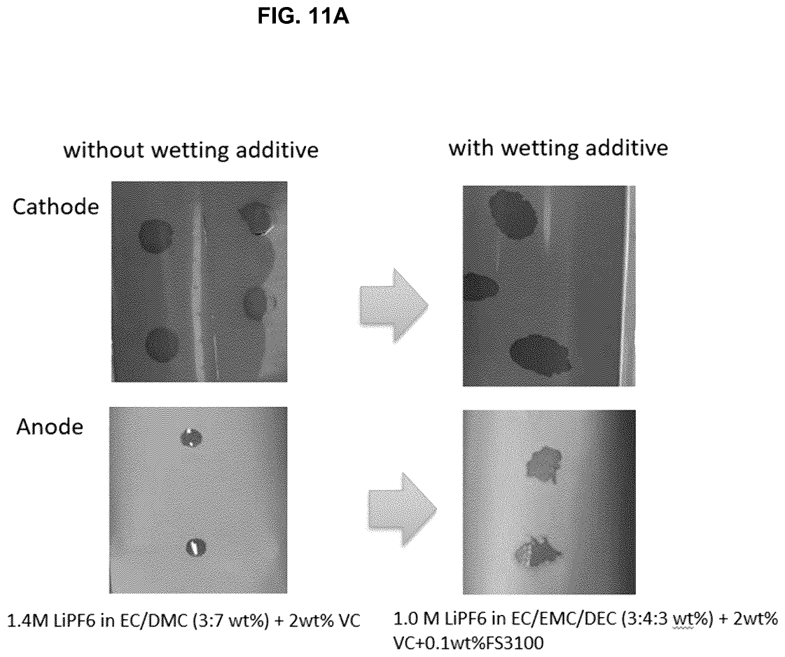

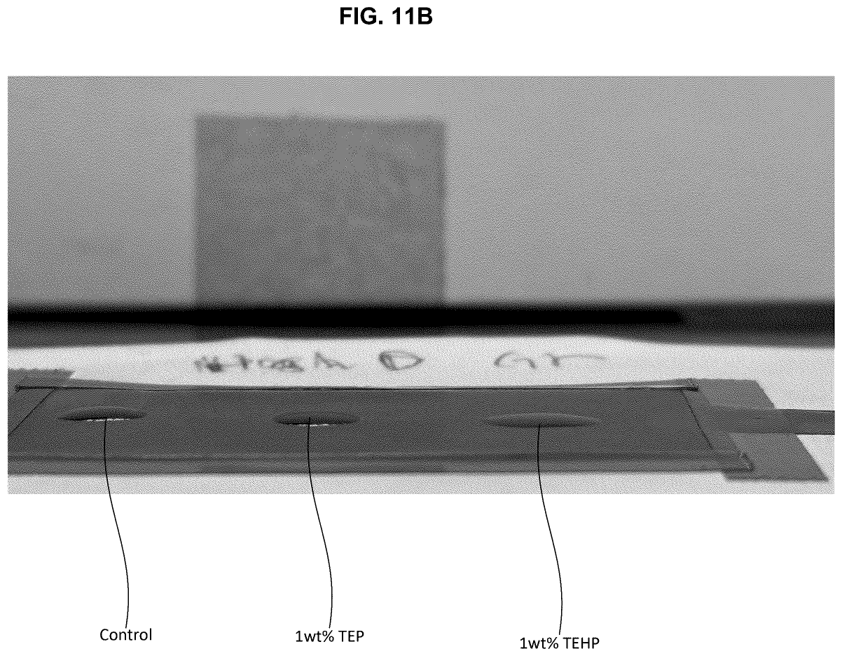

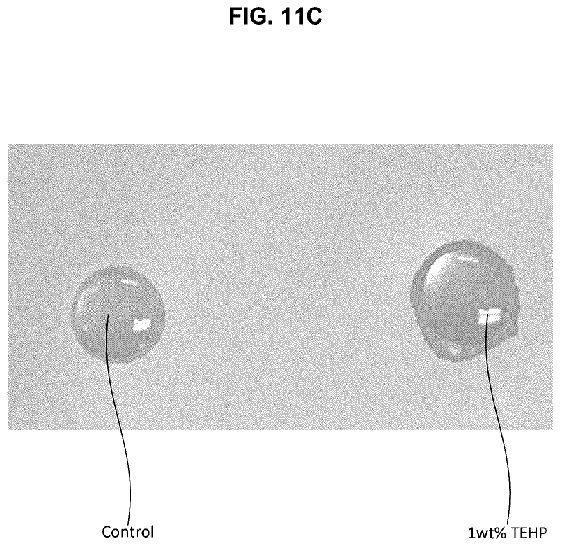

FIGS. 11A-11C show comparisons of the wetting of an electrode via electrodes with and without additives. Photos of electrodes after applying electrolyte with and without FS-3100 additive is shown in FIG. 11A. The control electrolyte includes 1.4M LiPF₆ in ethylene carbonate/dimethyl carbonate (EC/DMC) electrolyte in a ratio of about 3:7 wt %, and 2 wt % vinylene carbonate (VC) (left side of FIG. 11A). The example included the same electrolyte but included about 0.1 wt % FS-3100 wetting additive. Comparing the size of the electrolyte wetting area before and after electrolyte application, the electrolyte solution with additive clearly spreads to a larger area on both the cathode and the anode compared to the case without electrolyte additive FS-3100, which demonstrates the effectiveness of FS-3100 in facilitating electrolyte wetting. The effectiveness of electrolyte additives of TEP, TEHP is illustrated in FIG. 11B and FIG. 11C. In FIGS. 11B, 1 wt % TEP and 1 wt % TEHP are added to the electrolyte solution of FIG. 11A in separate solutions, and the electrolyte solutions are applied to an electrode material. In FIGS. 11C, 1 wt % TEHP is added to the electrolyte solution and the electrolyte solution is applied to a polyethylene separator. The larger spread area on the electrode material and on the separator indicates that the electrolyte additive improves the electrode and separator wetting.

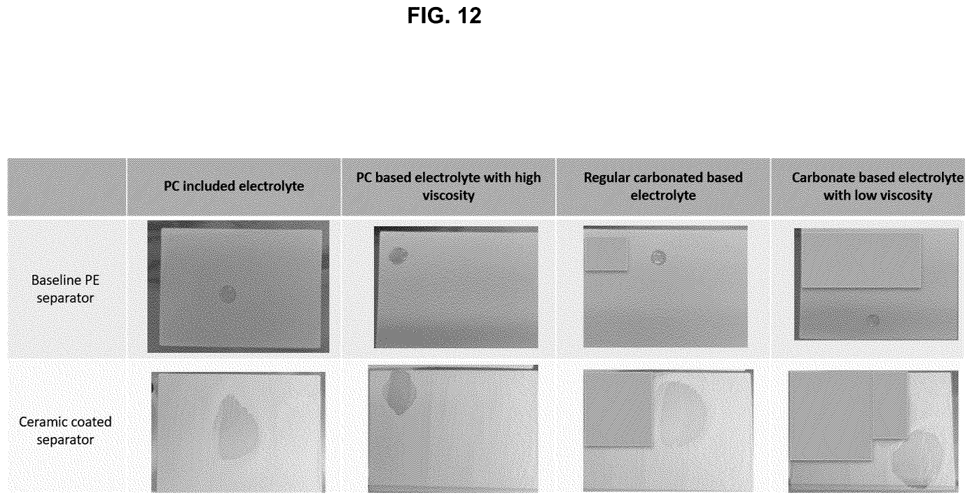

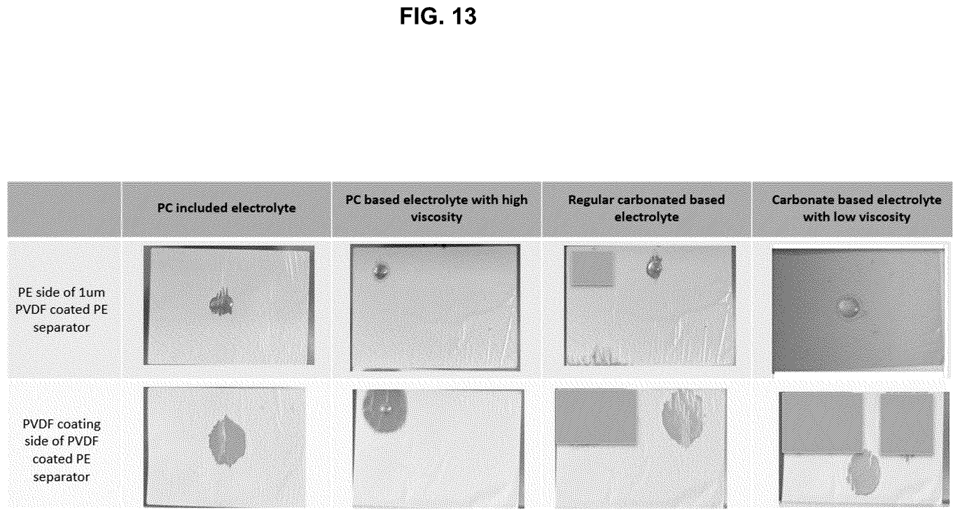

The advantage of a modified separator over baseline separator is demonstrated in FIG. 12 and FIG. 13. In FIG. 12, a baseline polyethylene separator is compared to a separator coated with boehmite. Various electrolytes were tested and the electrolyte wetting areas were observed. The electrolyte wetting area on the boehmite coated separator is significantly larger than those on uncoated polyethylene separators, which demonstrates the effectiveness of boehmite coating in improving electrolyte wetting. In FIG. 13, the PVDF coated separator shows a larger electrolyte wetting area corresponding to a contact angle of less than 90 degrees, compared to an uncoated polyethylene separator. In summary, ceramic and polymer coatings can improve electrolyte wetting by reducing the contact angle of electrolytes on polyolefin-based separators.

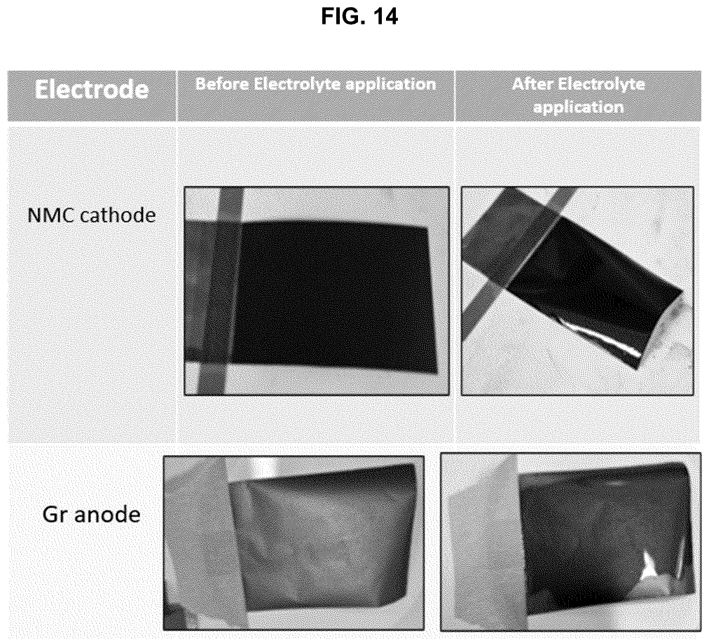

FIG. 14 shows electrolyte application results from the application of an electrolyte solution via a capillary nozzle to a lithium nickel manganese cobalt oxide (NMC) cathode and a graphite anode. After electrolyte application, the NMC and graphite electrode surfaces are fully covered with the electrolyte solution.

As previously described herein, electrode included in a semi-solid electrode (e.g., cathode and/or anode) may evaporate during manufacturing or operation. Replenishing the ions and/or solvents in the electrode via an electrolyte-containing material in contact with the anode can improve the performance of the electrochemical cell. For example, ion replenishment can extend lithium cycle life and stabilize the electrochemical cell's internal resistance significantly.

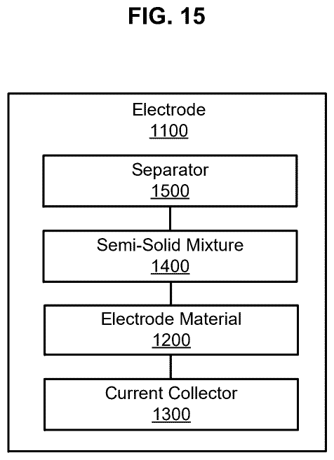

FIG. 15 is a block diagram of an electrode 1100 with a supply of electrolyte, according to an embodiment. As shown, the electrode 1100 includes an electrode material 1200 disposed on a current collector 1300, a semi-solid mixture 1400 disposed on the electrode material 1200, and a separator 1500 disposed on the semi-solid mixture 1400. The semi-solid mixture 1400 can provide a constant contact for wetting of the separator 1500.

In some embodiments, the electrode material 1200 can include an anode material. In some embodiments, the electrode material 1200 can include a cathode material. In some embodiments, the anode active material in the anode material can include lithium metal, one or more sheets of lithium metal, carbon, lithium-intercalated carbon, lithium nitrides, lithium alloys and lithium alloy forming compounds of silicon, bismuth, boron, gallium, indium, zinc, tin, tin oxide, antimony, aluminum, titanium oxide, molybdenum, germanium, manganese, niobium, vanadium, tantalum, gold, platinum, iron, copper, chromium, nickel, cobalt, zirconium, yttrium, molybdenum oxide, germanium oxide, silicon oxide, silicon carbide, any other materials or alloys thereof, and any other combination thereof. In some embodiments, the anode material can include a semi-solid anode material. In some embodiments, the anode material can include sodium metal, potassium metal, hard carbon, sodium or potassium-intercalated carbon, sodium-nitrides, potassium nitrides, sodium or potassium alloys, sodium or potassium alloy forming compounds, or any suitable combination thereof. In some embodiments, the electrode material 1200 may include an electrode used in an aqueous battery including, but not limited to Zn-Air battery electrodes, Zn—MnO₂ battery electrodes, Ni-magnesium hydride battery electrodes, Ni—Cd battery electrodes, any other aqueous battery electrode, or any suitable combination thereof. Suitable electrolytes for aqueous batteries may include, for example, lead-antimony alloys, tin, lead-calcium, lead-calcium tin, lead-tin, lead, nickel, stainless steel, titanium, silver, gold, platinum, any other suitable electrode, or any suitable combination thereof. In some embodiments, the electrode material 1200 may include an electrode used in a lead acid battery, for example, PbO₂ and Pb anodes.

In some embodiments, the current collector 1300 can include copper, aluminum, titanium, lead-antimony alloys, lead-calcium, tin, lead-tin, lead, nickel, stainless steel, silver, gold, platinum, or any combination thereof. In some embodiments, the current collector 1300 can include a mesh current collector. In some embodiments, the current collector 1300 can be coupled to less than an entire surface of the electrode material 1200, such that at least a portion of the electrode material 1200 is directly coupled to a film or pouch material (not shown). Examples of electrodes with electrode material directly coupled to a film material are described in U.S. patent application Ser. No. 17/181,554 (“the '554 application), filed Feb. 22, 2021 and entitled “Electrochemical Cells with Electrode Material Coupled Directly to Film and Methods of Making the Same,” the disclosure of which is hereby incorporated by reference in its entirety.

In some embodiments, the semi-solid mixture 1400 can be layered on the electrode material 1200 in a separate layer. In other words, the electrode material 1200 can form a first discrete layer of material and the semi-solid mixture 1400 can form a second discrete layer of material. In some embodiments, a gradual concentration gradient of lithium ions can form across the electrode material 1200 and the semi-solid mixture 1400. In some embodiments, the semi-solid mixture 1400 can include a conductive material and an electrolyte (e.g., a non-aqueous or aqueous electrolyte). In some embodiments, the semi-solid mixture 1400 can be absent of an active material. In some embodiments, the conductive material can include conductive carbon, activated carbon, graphite, hard carbon, soft carbon, carbon black, KETJEN BLACK® conductive particles, or any combination thereof.

In some embodiments, the electrolyte in the semi-solid mixture 1400 can include a non-aqueous electrolyte. In some embodiments, the non-aqueous electrolyte can include a solvent (e.g., an organic solvent). In some embodiments, the non-aqueous electrolyte can include ethylene carbonate, dimethyl carbonate, ethyl acetate, vinylene carbonate, or any combination thereof. In some embodiments, the solvent can include, for example, ethylene carbonate, propylene carbonate, dimethyl carbonate, diethyl carbonate, ethyl methyl carbonate, dimethyl sulfoxide, acetonitrile, γ-butyrolactone, tetrahydrofuran, sulfolane, diethylene glycol dimethyl ether (glyme), dimethylformamide, propylene glycol dimethyl ether, any other suitable solvent, or any suitable combination thereof. In some embodiments, the electrolyte can include a lithium-containing salt. In some embodiments, the lithium-containing salt can include lithium hexafluorophosphate (LiPF₆), lithium bis(fluorosulfonyl)imide (LiFSI), or any combination thereof. In some embodiments, the electrolyte can include an aqueous electrolyte such as, for example, NaCl, KCl, ZnCl₂, ZnBr₂, sulfuric acid, hydrochloric acid, ammonium chloride, zinc sulfate, copper sulfate, sodium hydroxide, acetic acid, lithium chloride, any other suitable electrolyte, or any suitable combination thereof.

In some embodiments, the electrolyte can have a salt concentration of at least about 0.5 M, at least about 1 M, at least about 1.5 M, at least about 2 M, at least about 2.5 M, at least about 3 M, at least about 3.5 M, at least about 4 M, or at least about 4.5 M. In some embodiments, the electrolyte can have a salt concentration of no more than about 5 M, no more than about 4.5 M, no more than about 4 M, no more than about 3.5 M, no more than about 3 M, no more than about 2.5 M, no more than about 2 M, no more than about 1.5 M, or no more than about 1 M. Combinations of the above-referenced salt concentrations in the electrolyte are also possible (e.g., at least about 0.5 M and no more than about 5 M or at least about 2 M and no more than about 4 M), inclusive of all values and ranges therebetween. In some embodiments, the electrolyte can have a salt concentration of about 0.5 M, about 1 M, about 1.5 M, about 2 M, about 2.5 M, about 3 M, about 3.5 M, about 4 M, about 4.5 M, or about 5 M.

In some embodiments, the semi-solid mixture 1400 can include at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, or at least about 19% by volume of conductive material. In some embodiments, the semi-solid mixture 1400 can include no more than about 20%, no more than about 19%, no more than about 18%, no more than about 17%, no more than about 16%, no more than about 15%, no more than about 14%, no more than about 13%, no more than about 12%, no more than about 11%, no more than about 10%, no more than about 9%, no more than about 8%, no more than about 7%, no more than about 6%, no more than about 5%, no more than about 4%, no more than about 3%, no more than about 2%, no more than about 1%, no more than about 0.9%, no more than about 0.8%, no more than about 0.7%, no more than about 0.6%, no more than about 0.5%, no more than about 0.4%, no more than about 0.3%, or no more than about 0.2% by volume of conductive material.

Combinations of the above-referenced volume percentages of conductive material in the semi-solid mixture 1400 are also possible (e.g., at least about 0.1% and no more than about 20% or at least about 2% and no more than about 5%), inclusive of all values and ranges therebetween. In some embodiments, the semi-solid mixture 1400 can include about 0.1%, about 0.2%, about 0.3%, about 0.4%, about 0.5%, about 0.6%, about 0.7%, about 0.8%, about 0.9%, about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% by volume of conductive material.

In some embodiments, the semi-solid mixture 1400 can include at least about 80%, at least about 81%, about 82%, about 83%, about 84%, about 85%, about 86%, about 87%, about 88%, about 89%, at least about 90%, at least about 91%, at least about 92%, at least about 93%, at least about 94%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, or at least about 99.8% by volume of electrolyte. In some embodiments, the semi-solid mixture 1400 can include no more than about 99.9%, no more than about 99.8%, no more than about 99.7%, no more than about 99.6%, no more than about 99.5%, no more than about 99.4%, no more than about 99.3%, no more than about 99.2%, no more than about 99.1%, no more than about 99%, no more than about 98%, no more than about 97%, no more than about 96%, no more than about 95%, no more than about 94%, no more than about 93%, no more than about 92%, no more than about 91%, no more than about 90%, no more than about 89%, no more than about 88%, no more than about 87%, no more than about 86%, no more than about 85%, no more than about 84%, no more than about 83%, no more than about 82%, or no more than about 81% by volume of the electrolyte.

Combinations of the above-referenced volume percentages of the electrolyte in the semi-solid mixture 1400 are also possible (e.g., at least about 80% and no more than about 99.9% or at least about 95% and no more than about 98%), inclusive of all values and ranges therebetween. In some embodiments, the semi-solid mixture 1400 can include about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 99.1%, about 99.2%, about 99.3%, about 99.4%, about 99.5%, about 99.6%, about 99.7%, about 99.8%, or about 99.9% by volume of electrolyte.

In some embodiments, the semi-solid mixture 1400 can have a slurry consistency. In some embodiments, the semi-solid mixture 1400 can have a paste-like consistency. In some embodiments, the semi-solid mixture may include ceramic(s) (e.g., ceramic particles incorporated into the semi-solid mixture 1400), for example, to increase a viscosity or adjust flowability of the semi-solid mixture 1400. Suitable ceramics may include, but are not limited to aluminum oxide, silicon carbon, zirconium dioxide, titanium dioxide, silicon dioxide, boron carbide, yttrium oxide, magnesium oxide, aluminum nitride, barium titanate, any other suitable ceramic, or any suitable combination thereof.

In some embodiments, the semi-solid mixture 1400 can be castable. In some embodiments, the semi-solid mixture 1400 can have a viscosity of at least about 10 Pa·s, at least about 20 Pa·s, at least about 30 Pa·s, at least about 40 Pa·s, at least about 50 Pa·s, at least about 60 Pa·s, at least about 70 Pa·s, at least about 80 Pa·s, at least about 90 Pa·s, at least about 100 Pa·s, at least about 200 Pa·s, at least about 300 Pa·s, at least about 400 Pa·s, at least about 500 Pa·s, at least about 600 Pa·s, at least about 700 Pa·s, at least about 800 Pa·s, or at least about 900 Pa·s. In some embodiments, the semi-solid mixture 1400 can have a viscosity of no more than about 1,000 Pa·s, no more than about 900 Pa·s, no more than about 800 Pa·s, no more than about 700 Pa·s, no more than about 600 Pa·s, no more than about 500 Pa·s, no more than about 400 Pa·s, no more than about 300 Pa·s, no more than about 200 Pa·s, no more than about 100 Pa·s, no more than about 90 Pa·s, no more than about 80 Pa·s, no more than about 70 Pa·s, no more than about 60 Pa·s, no more than about 50 Pa·s, no more than about 40 Pa·s, no more than about 30 Pa·s, or no more than about 20 Pa·s. Combinations of the above-referenced viscosity values of the semi-solid mixture 1400 are also possible (e.g., at least about 10 Pa·s and no more than about 1,000 Pa·s or at least about 100 Pa·s and no more than about 500 Pa·s), inclusive of all values and ranges therebetween. In some embodiments, the semi-solid mixture 1400 can have a viscosity of about 10 Pa·s, about 20 Pa·s, about 30 Pa·s, about 40 Pa·s, about 50 Pa·s, about 60 Pa·s, about 70 Pa·s, about 80 Pa·s, about 90 Pa·s, about 100 Pa·s, about 200 Pa·s, about 300 Pa·s, about 400 Pa·s, about 500 Pa·s, about 600 Pa·s, about 700 Pa·s, about 800 Pa·s, about 900 Pa·s, or about 1,000 Pa·s. In some embodiments, the semi-solid mixture 1400 can have a gradient viscosity that varies along the thickness of the semi-solid mixture 1400.

In some embodiments, the separator 1500 can contact the semi-solid mixture 1400 such that the separator 1500 can be constantly wetted during cycling. In some embodiments, the semi-solid mixture 1400 can provide lithium ion and/or solvents (e.g., electrolyte) for consumption to the electrode material 1200 while providing a constant contact for wetting of the separator 1500.

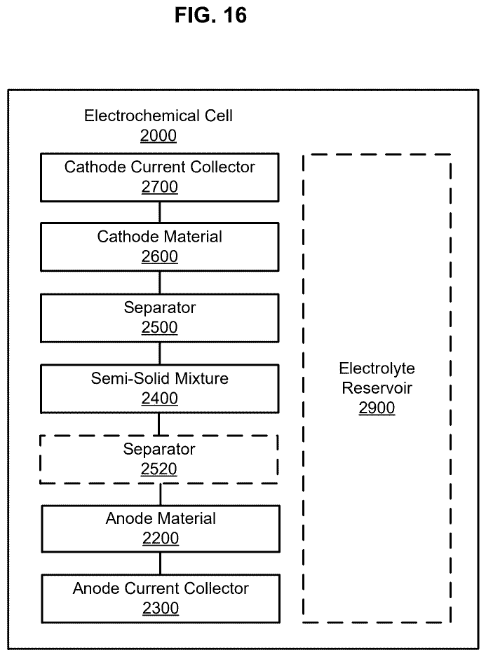

FIG. 16 is a block diagram of an electrochemical cell 2000 with an electrolyte supply, according to an embodiment. As shown, the electrochemical cell 2000 can include an anode material 2200 disposed on an anode current collector 2300, a semi-solid mixture 2400 disposed on the anode material 2200, a cathode material 2600 disposed on a cathode current collector 2700, a separator 2500 (e.g., a first separator 2500) disposed between the cathode material 2600 and the semi-solid mixture 2400, and optionally, a second separator 2520 disposed between the anode material 2200 and the semi-solid mixture 2400, and an electrolyte reservoir 2900 fluidically coupled to at least one of the anode material 2200 the semi-solid mixture, 2400, the separator 2500, or the cathode material 2600. In some embodiments, the anode material 2200, the anode current collector 2300, the semi-solid mixture 2400, and the separator 2500 can be the same or substantially similar to the electrode material 1200, the current collector 1300, the semi-solid mixture 1400, and the separator 1500, as described above with reference to FIG. 15. Thus, certain aspects of the anode material 2200, the anode current collector 2300, the semi-solid mixture 2400, and the separator 2500 are not described in greater detail herein.

In some embodiments, the cathode material 2600 can include a semi-solid cathode material. In some embodiments, the cathode material 2600 can include a mixture of an active material, a conductive material and a non-aqueous liquid electrolyte. In some embodiments, the cathode material 2600 can include at least about 30%, at least about 35%, at least about 40%, at least about 45%, at least about 50%, at least about 55%, at least about 60%, at least about 65%, at least about 70%, at least about 75%, at least about 80%, at least about 84%, or at least about 84.5% by volume of an active material. In some embodiments, the cathode material 2600 can include at least about 30%, at least about 35%, at least about 40%, at least about 45%, at least about 50%, at least about 55%, at least about 60%, at least about 65%, at least about 70%, at least about 75%, or at least about 80% by volume of an active material. In some embodiments, the cathode material 2600 can include no more than about 85%, no more than about 84.5%, no more than about 84%, no more than about 80%, no more than about 75%, no more than about 70%, no more than about 65%, no more than about 60%, no more than about 55%, no more than about 50%, no more than about 45%, no more than about 40%, or no more than about 35% by volume of an active material. Combinations of the above-referenced volumetric percentages of active material in the cathode material 2600 are also possible (e.g., at least about 30% and no more than about 85% or at least about 40% and no more than about 60%), inclusive of all values and ranges therebetween. In some embodiments, the cathode material 2600 can include about 30%, about 35%, about 40%, about 45%, about 50%, about 55%, about 60%, about 65%, about 70%, about 75%, about 80%, about 84%, about 84.5%, or about 85% by volume of an active material.

In some embodiments, the cathode material 2600 can include at least about 0.5%, at least about 1%, at least about 1.5%, at least about 2%, at least about 2.5%, at least about 3%, at least about 3.5%, at least about 4%, at least about 4.5%, at least about 5%, at least about 5.5%, at least about 6%, at least about 6.5%, at least about 7%, at least about 7.5%, at least about 8%, at least about 8.5%, at least about 9%, at least about 9.5%, at least about 10%, at least about 15%, at least about 20%, or at least about 25% by volume of a conductive material. In some embodiments, the cathode material 2600 can include no more than about 30%, no more than about 25%, no more than about 20%, no more than about 15%, no more than about 10%, no more than about 9.5%, no more than about 9%, no more than about 8.5%, no more than about 8%, no more than about 7.5%, no more than about 7%, no more than about 6.5%, no more than about 6%, no more than about 5.5%, no more than about 5%, no more than about 4.5%, no more than about 4%, no more than about 3.5%, no more than about 3%, no more than about 2.5%, no more than about 2%, no more than about 1.5%, or no more than about 1% by volume of a conductive material. Combinations of the above-referenced volumetric percentages of conductive material in the cathode material 2600 are also possible (e.g., at least about 0.5% and no more than about 30% or at least about 5% and no more than about 10%), inclusive of all values and ranges therebetween. In some embodiments, the cathode material 2600 can include about 0.5%, about 1%, about 1.5%, about 2%, about 2.5%, about 3%, about 3.5%, about 4%, about 4.5%, about 5%, about 5.5%, about 6%, about 6.5%, about 7%, about 7.5%, about 8%, about 8.5%, about 9%, about 9.5%, about 10%, about 15%, about 20%, about 25%, or about 30% by volume of a conductive material.

In some embodiments, the cathode material 2600 can include at least about 15%, at least about 20%, at least about 25%, at least about 30%, at least about 35%, at least about 40%, at least about 45%, at least about 50%, or at least about 55% by volume of an electrolyte. In some embodiments, the cathode material 2600 can include no more than about 60%, no more than about 55%, no more than about 50%, no more than about 45%, no more than about 40%, no more than about 35%, no more than about 30%, no more than about 25%, or no more than about 20% by volume of an electrolyte. Combinations of the above-referenced volumetric percentages of electrolyte in the cathode material 2600 are also possible (e.g., at least about 15% and no more than about 60% or at least about 20% and no more than about 40%), inclusive of all values and ranges therebetween. In some embodiments, the cathode material 2600 can include about 15%, about 20%, about 25%, about 30%, about 35%, about 40%, about 45%, about 50%, about 55%, or about 60% by volume of an electrolyte.

In some embodiments, the semi-solid cathode material can have a composition the same or substantially similar to electrode compositions described in the '159 patent. Further examples of electrode compositions are described in U.S. patent application Ser. No. 17/152,950 (“the '950 application”), filed Jan. 20, 2021, entitled “Apparatuses and Processes for Forming a Semi-Solid Electrode Having High Active Solids Loading and Electrochemical Cells,” the disclosure of which is hereby incorporated by reference in its entirety.

In some embodiments, the cathode material 2600 can have a slurry consistency. In some embodiments, the cathode material can have a paste-like consistency. In some embodiments, the cathode material 2600 can be castable. In some embodiments, the cathode material 2600 can have a viscosity of at least about 10 Pa·s, at least about 20 Pa·s, at least about 30 Pa·s, at least about 40 Pa·s, at least about 50 Pa·s, at least about 60 Pa·s, at least about 70 Pa·s, at least about 80 Pa·s, at least about 90 Pa-s, at least about 100 Pa·s, at least about 200 Pa·s, at least about 300 Pa·s, at least about 400 Pa·s, at least about 500 Pa·s, at least about 600 Pa·s, at least about 700 Pa·s, at least about 800 Pa·s, or at least about 900 Pa·s. In some embodiments, the cathode material 2600 can have a viscosity of no more than about 1,000 Pa·s, no more than about 900 Pa·s, no more than about 800 Pa·s, no more than about 700 Pa·s, no more than about 600 Pa·s, no more than about 500 Pa·s, no more than about 400 Pa·s, no more than about 300 Pa·s, no more than about 200 Pa·s, no more than about 100 Pa·s, no more than about 90 Pa·s, no more than about 80 Pa·s, no more than about 70 Pa·s, no more than about 60 Pa·s, no more than about 50 Pa·s, no more than about 40 Pa·s, no more than about 30 Pa·s, or no more than about 20 Pa·s. Combinations of the above-referenced viscosity values of the cathode material 2600 are also possible (e.g., at least about 10 Pa·s and no more than about 1,000 Pa·s or at least about 100 Pa·s and no more than about 500 Pa. s), inclusive of all values and ranges therebetween. In some embodiments, the cathode material 2600 can have a viscosity of about 10 Pa·s, about 20 Pa·s, about 30 Pa·s, about 40 Pa·s, about 50 Pa·s, about 60 Pa·s, about 70 Pa-s, about 80 Pa·s, about 90 Pa·s, about 100 Pa·s, about 200 Pa·s, about 300 Pa·s, about 400 Pa·s, about 500 Pa-s, about 600 Pa-s, about 700 Pa·s, about 800 Pa·s, about 900 Pa·s, or about 1,000 Pa·s. In some embodiments, the cathode material 2600 can have a gradient viscosity that varies along the thickness of the cathode material 2600.

In some embodiments, the second separator 2520 may be disposed between the anode material 2200 and the semi-solid mixture 2400. In other words, the semi-solid mixture 2400 may be interposed between the first separator 2500 and the second separator 2520. This implementation may beneficially allow the semi-solid mixture 2400 to be isolated from the components (e.g., electroactive material, conductive material, and/or electrolyte) of each of the anode material 2200 and the cathode material 2600. This may advantageously inhibit side reactions of the components the semi-solid mixture 2400 and degradation thereof, for example, when exposed to electrode potential. In some embodiments, the second separator 2520 may be substantially similar in structure and function to the first separator 2500.

As shown in FIG. 16, in some embodiments, the electrochemical cell 2000 can be included in a cell assembly, that also includes an electrolyte reservoir 2900 in addition to, or alternatively to the semi-solid mixture 2400. For example, the electrochemical cell 2000 can be disposed in a housing (e.g., a container or a pouch) within which the electrolyte reservoir 2900 is also disposed. In some embodiments, the electrolyte reservoir 2900 can include a chamber or container that contains or holds a volume of the electrolyte. In some embodiments, the electrolyte reservoir 2900 may include a chamber defined in the housing. In some embodiments, the electrolyte reservoir 2900 may include a separate chamber that is disposed in the housing. In some embodiments, the electrolyte reservoir 2900 may include a block of a porous material, for example, polyethylene, activated carbon, silica gel, zeolites, aerogels, hydrogels, metal organic frameworks, porous silicon, porous polymers, mesoporous silica, biochar, pumice, foam, cordierite, microporous carbon, porous ceramic, porous metal, sponge, any others suitable porous material, or any suitable combination thereof, that can hold a volume of the electrolyte.

In some embodiments, the electrolyte reservoir 2900 may include a plurality of layers of a porous material (e.g., polyethylene or any other porous material described herein) disposed or stacked on top of each other, and configured to hold the volume of the electrolyte. In some embodiments, each layer may have a thickness in a range of 10 μm to about 1,000 μm, inclusive (e.g., about 10 μm, about 20 μm, about 30 μm, about 40 μm, about 50 μm, about 100 μm, about 200 μm, about 300 μm, about 400 μm, about 500 μm, about 600 μm, about 700 μm, about 800 μm, about 900 μm, or about 1,000 μm, inclusive of all ranges and values therebetween). In some embodiments, the plurality of layers of the porous material may have an area in a range of about 10×10 mm² to 100×100mm², inclusive. In some embodiments, the plurality of layers of the porous material may include the same material as the separator (e.g., polyethylene). In some embodiments, the one or more layers of the porous material may be wrapped around at least a portion of the electrochemical cell 2000, for example, wrapped around one or more side faces, and disposed at least partially on a top or bottom surface of the electrochemical cell 2000.

In some embodiments, the electrolyte reservoir 2900 may be configured to communicate the electrolyte to the separator 2500 (and/or 2520) and/or the semi-solid mixture 2400, via capillary action. For example, the cell assembly may include a capillary channel (not shown) fluidically coupling the electrolyte reservoir 2900 to the separator 2500, the separator 2520, and/or the semi-solid mixture 2400. For example, in some embodiments, the capillary channel may include a strip of a porous material having a first end fluidically coupled to the electrolyte reservoir 2900 and a second end opposite the first end, which is fluidically coupled to the separator 2500, or any other layer of the electrochemical cell 2000, for example, the second separator 2520 and/or the semi-solid mixture 2400. In some embodiments, the capillary channel may include a tab extending from the separator 2500 (and/or 2520) into the electrolyte reservoir 2900 so as to provide capillary pressure or concentration gradient based electrolyte transport to the separator 2500 (e.g., replenish lithium ions and solvents). In some embodiments, the electrolyte reservoir 2900 may be configured to replenish electrolyte via evaporation and vapor pressure. For example, the electrolyte reservoir 2900 may include a block of porous material or a plurality of layers of porous material as described herein, that contains a volume of the electrolyte contained within the pores thereof. The electrolyte may evaporate to form vapors of the electrolyte in the internal volume of the housing and cause a vapor pressure of the electrolyte to be present in the housing. At least a portion of the separator 2500, the separator 2520, and or the semi-solid mixture 2400 may be exposed to the internal volume of the housing, through which any electrolyte lost during operation of the electrochemical cell 2000 may be replenished by the vapors of the electrolyte present in the housing, for example, due to vapor pressure and/or concentration gradient driven transport.

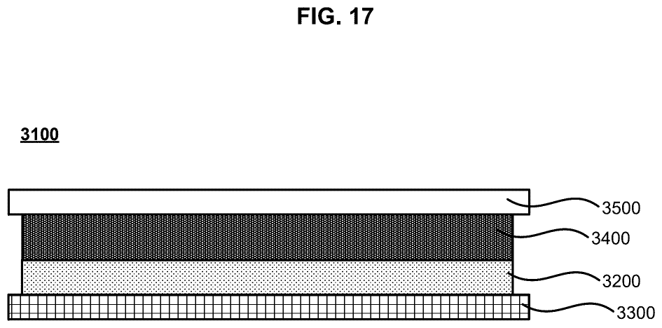

FIG. 17 shows an illustration of an electrode 3100, according to an embodiment. As shown, the electrode 3100 includes an electrode material 3200, a current collector 3300, a semi-solid mixture 3400, and a separator 3500. In some embodiments, the electrode material 3200, the current collector 3300, the semi-solid mixture 3400, and the separator 3500 can be the same or substantially similar to the electrode material 1200, the current collector 1300, the semi-solid mixture 1400, and the separator 1500, as described above with reference to FIG. 15. Thus, certain aspects of the electrode material 3200, the current collector 3300, the semi-solid mixture 3400, and the separator 3500 are not described in greater detail herein.

As shown, the electrode 3100 includes a single layer of the semi-solid mixture 3400. In some embodiments, the electrode 3100 can include multiple layers of the semi-solid mixture 3400. In some embodiments, the electrode 3100 can include 2, 3, 4, 5, 6, 7, 8, 9, 10, or at least about 10 layers of the semi-solid mixture 3400. In some embodiments, the semi-solid mixture 3400 can have a thickness of at least about 20 μm, at least about 30 μm, at least about 40 μm, at least about 50 μm, at least about 60 μm, at least about 70 μm, at least about 80 μm, at least about 90 μm, at least about 100 μm, at least about 150 μm, at least about 200 μm, at least about 250 μm, at least about 300 μm, at least about 350 μm, at least about 400 μm, or at least about 450 μm. In some embodiments, the semi-solid mixture 3400 can have a thickness of no more than about 500 μm, no more than about 450 μm, no more than about 400 μm, no more than about 350 μm, no more than about 300 μm, no more than about 250 μm, no more than about 200 μm, no more than about 150 μm, no more than about 100 μm, no more than about 90 μm, no more than about 80 μm, no more than about 70 μm, no more than about 60 μm, no more than about 50 μm, no more than about 40 μm, or no more than about 30 μm. Combinations of the above-referenced thicknesses of the semi-solid mixture 3400 are also possible (e.g., at least about 20 μm and no more than about 500 μm or at least about 100 μm and no more than about 250 μm), inclusive of all values and ranges therebetween. In some embodiments, the semi-solid mixture 3400 can have a thickness of about 20 μm, about 30 μm, about 40 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, or about 500 μm.

In some embodiments, the semi-solid mixture 3400 can have a thickness greater than a thickness of the electrode material 3200. In some embodiments, the thickness of the semi-solid mixture 3400 can be less than the thickness of the electrode material 3200. In some embodiments, the thickness of the semi-solid mixture 3400 can be the same or substantially similar to the thickness of the electrode material 3200. In some embodiments, the electrode material 3200 can include multiple layers. In some embodiments, the electrode material 3200 can have concentration gradients, a density gradient, and/or a porosity gradient. Examples of electrodes with multiple layers and/or gradients are further described in U.S. Patent publication no. 2019/0363351 (“the '351 publication”), filed May 24, 2019, entitled “High Energy-Density Composition-Gradient Electrodes and Methods of Making the Same,” the disclosure of which is hereby incorporated by reference in its entirety.

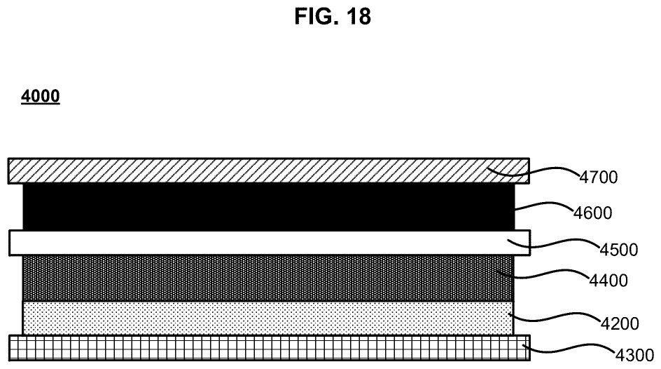

FIG. 18 shows an illustration of an electrochemical cell 4000, according to an embodiment. As shown, the electrochemical cell 4000 includes an anode material 4200 disposed on an anode current collector 4300, a semi-solid mixture 4400 disposed on the anode material 4200, a cathode material 4600 disposed on a cathode current collector 4700, and a separator 4500 disposed between the cathode current collector 4700 and the semi-solid mixture 4400. In some embodiments, the anode material 4200, the anode current collector 4300, the semi-solid mixture 4400, the separator 4500, the cathode material 4600, and the current collector 4700 can be the same or substantially similar to the anode material 2200, the anode current collector 2300, the semi-solid mixture 2400, the separator 2500, the cathode material 2600, and the current collector 2700, as described above with reference to FIG. 16. Thus, certain aspects of the anode material 4200, the anode current collector 4300, the semi-solid mixture 4400, the separator 4500, the cathode material 4600, and the current collector 4700 are not described in greater detail herein.

As shown, the semi-solid mixture 4400 is disposed adjacent to the anode material 4200. In other words, the semi-solid mixture 4400 is shown disposed on the “anode side” of the separator 4500. In some embodiments, the semi-solid mixture 4400 can be disposed adjacent to the cathode material 4600 (i.e., on the “cathode side” of the separator 4500). In some embodiments, the semi-solid mixture 4400 can be disposed on both the anode side and the cathode side of the separator 4500. In other words, a first semi-solid mixture can be disposed on the anode side of the separator 4500 and a second semi-solid mixture can be disposed on the cathode side of the separator 4500.

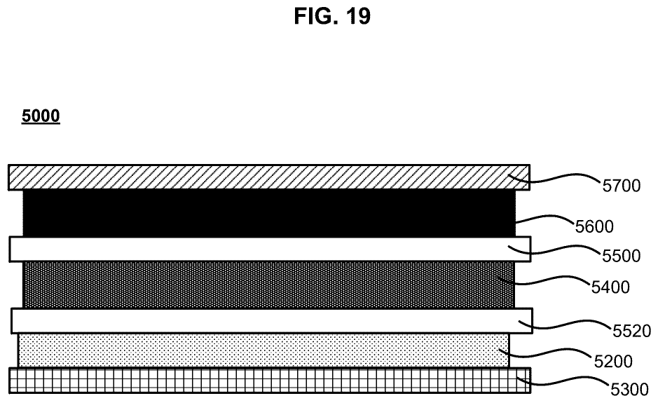

In some embodiments, an electrolyte supply, for example, a semi-solid mixture may be disposed between two separator layers. For example, FIG. 19 is an illustration of an electrochemical cell 5000 with a supply of electrolyte, according to an embodiment. As shown, the electrochemical cell 5000 includes an anode material 5200 disposed on an anode current collector 5300, a semi-solid mixture 5400 disposed on the anode material 5200, a cathode material 5600 disposed on a cathode current collector 5700, and a first separator 5500 disposed between the cathode current collector 5700 and the semi-solid mixture 5400.

Different from the electrochemical cell 4000, the electrochemical cell 5000 also includes a second separator 5520 disposed between the anode material 5200 and the semi-solid mixture 5400. In other words, the semi-solid mixture 5400 is disposed between the first separator 5500 and the second separator 5520. This implementation may beneficially allow the semi-solid mixture 5400 to be isolated from the components (e.g., electroactive material, conductive material, and/or electrolyte) of each of the anode material 5200 and the cathode material 5600, thus inhibiting side reactions of the materials of the semi-solid mixture 5400 and degradation thereof, for example, when exposed to electrode potential. In some embodiments, the anode material 5200, the anode current collector 5300, the semi-solid mixture 5400, the first separator 5500, the second separator 5520, the cathode material 5600, and the current collector 5700 can be the same or substantially similar to the anode material 2200, the anode current collector 2300, the semi-solid mixture 2400, the first separator 2500, the second separator 2520, the cathode material 2600, and the current collector 2700, as described above with reference to FIG. 16, and therefore, not described in further detail herein.

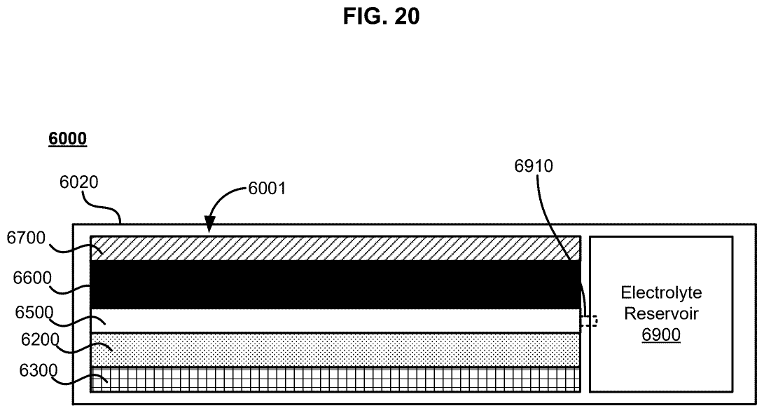

In some embodiments, an electrochemical cell assembly may include an electrochemical cell and an electrolyte reservoir in addition to, or alternatively to an electrolyte supply that that may be included in the electrochemical cell. For example, FIG. 20 is an illustration of an electrochemical cell assembly 6000 including an electrochemical cell 6001 and electrolyte reservoir 690, according to an embodiment. As shown, the electrochemical cell 6001 includes an anode material 6200 disposed on an anode current collector 6300, a semi-solid mixture 640 disposed on the anode material 6200, a cathode material 6600 disposed on a cathode current collector 6700, and a separator 6500 disposed between the cathode current collector 6700 and the semi-solid mixture 640. In some embodiments, the anode material 6200, the anode current collector 6300, the semi-solid mixture 640, the separator 6500, the cathode material 6600, and the current collector 6700 can be the same or substantially similar to the anode material 2200, the anode current collector 2300, the semi-solid mixture 2400, the separator 2500, the cathode material 2600, and the current collector 2700, as described above with reference to FIG. 16, and therefore, not described in further detail herein. While not shown, in some embodiments, the electrochemical cell 6001 may also include a second separator, for example, the second separator 5520 as described with respect to the electrochemical cell 5000 such that the semi-solid mixture 5400 is disposed between two separators, as previously described herein. In some embodiments, the semi-solid mixture 640 may be excluded.

The electrochemical cell 6001 and the electrolyte reservoir 690 may be disposed in an internal volume defined by a housing 6020. In some embodiments, the housing 6020 may include a pouch, for example, a laminated pouch. In some embodiments, the housing 6020 may be formed from a rigid material, for example, plastics, metals, polymers, or any suitable combination thereof. In some embodiments, the housing 6020 may be substantially hermetically sealed so as to inhibit ingress of moisture into the internal volume of loss of electrolyte therefrom.

As shown in FIG. 20, the electrolyte reservoir 6900 is also disposed in the housing 6020. For example, the electrolyte reservoir 6900 may be disposed adjacent to the electrochemical cell 6001 or in contact with the electrochemical cell 6001. In some embodiments, the electrolyte reservoir 6900 can include a chamber or container that contains or holds a volume of the electrolyte. In some embodiments, the electrolyte reservoir 6900 may include a chamber defined in the housing 6020. In some embodiments, the electrolyte reservoir 6900 may include a separate chamber or container that is disposed in the housing 6020. In some embodiments, the electrolyte reservoir 6900 may include a block of a porous material (e.g., polyethylene, activated carbon, silica gel, zeolites, aerogels, hydrogels, metal organic frameworks, porous silicon, porous polymers, mesoporous silica, biochar, pumice, foam, cordierite, microporous carbon, porous ceramic, porous metal, sponge, any others suitable porous material, or any suitable combination thereof), that can hold a volume of the electrolyte.

In some embodiments, the electrolyte reservoir 6900 may be configured to communicate the electrolyte to the separator 6500 and/or the semi-solid mixture 6400, via capillary action. For example, the cell assembly 6000 may include a capillary channel 6910 fluidically coupling the electrolyte reservoir 6900 to the separator 6500 and/or the semi-solid mixture 6400. For example, in some embodiments, the capillary channel 6910 may include a strip of a porous material (e.g., polyethylene, cellulose, carbon form, etc.) having a first end fluidically coupled to the electrolyte reservoir 6900 and a second end opposite the first end, which is fluidically coupled to the separator 6500, and/or the semi-solid mixture 6400. In some embodiments, the capillary channel 6910 may include a tab extending from the separator 6500 or the semi-solid mixture 6400 into the electrolyte reservoir 6900 so as to provide capillary pressure or concentration gradient based electrolyte transport to the electrochemical cell 6001 (e.g., replenish lithium ions and solvents). In some embodiments, the electrolyte reservoir 6900 may be configured to replenish electrolyte via evaporation and vapor pressure. For example, the electrolyte reservoir 6900 may include a block of porous material (e.g., a block of polyethylene, foam, carbon, aerogel, hydrogel, etc.) that contains a volume of the electrolyte contained within the pores of the porous material. The electrolyte may evaporate so as to form vapors of the electrolyte in the internal volume of the housing 6020 to cause a vapor pressure of the electrolyte (or at least solvents included in the electrolyte) to be present in the housing 6020. At least a portion of the separator 6500 and/or the semi-solid mixture 6400 may be exposed to the internal volume of the housing 6020, through which any electrolyte lost during operation of the electrochemical cell 6001 may be replenished by the vapors of the electrolyte present in the internal volume of the housing 6020, for example, due to vapor pressure and/or concentration gradient driven transport.

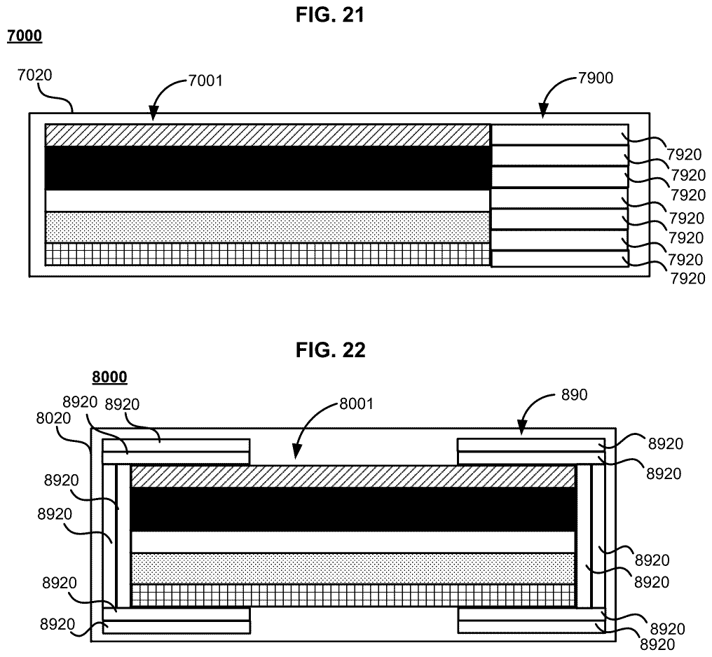

In some embodiments, an electrochemical cell assembly may include an electrolyte reservoir that includes a plurality of layers of a porous material. For example, FIG. 21 is an illustration of an electrochemical cell assembly 7000 including an electrochemical cell 7001, and an electrolyte reservoir 7900 disposed in an internal volume defined by a housing 7020. The electrochemical cell 7001 and the housing 7020 may be substantially similar to the electrochemical cell 6001 and the housing 7020 and therefore, not described in further detail herein. As shown in FIG. 21, the electrolyte reservoir 7900 may include a plurality of layers 7920 of a porous material (e.g., polyethylene or any other porous material described herein) disposed or stacked on top of each other, and disposed adjacent to the electrochemical cell 7001 in the housing 7020. Each of the plurality of layers 7920 may be configured to hold a volume of an electrolyte. In some embodiments, each layer 7920 may have a thickness in a range of about 10 μm to about 1,000 μm, inclusive (e.g., about 10 μm, about 20 μm, about 30 μm, about 40 μm, about 50 μm, about 100 μm, about 200 μm, about 300 μm, about 400 μm, about 500 μm, about 600 μm, about 700 μm, about 800 μm, about 900 μm, or about 1,000 μm, inclusive of all ranges and values therebetween). In some embodiments, the plurality of layers 7920 of the porous material may have an area in a range of about 10×10 mm² to 100×100mm², inclusive. In some embodiments, the plurality of layers of the porous material may include the same material as the separator (e.g., polyethylene).

In some embodiments, one or more porous layers containing the electrolyte may be wrapped around at least a portion of an electrochemical cell included in an electrochemical cell assembly. For example, FIG. 22 is an illustration of an electrochemical cell 8001 that includes an electrochemical cell assembly 8000 including an electrochemical cell 8001, and an electrolyte reservoir 8900 disposed in an internal volume defined by a housing 8020. The electrochemical cell 8001 and the housing 8020 may be substantially similar to the electrochemical cell 8001 and the housing 8020 and therefore, not described in further detail herein. As shown in FIG. 22, the electrolyte reservoir 8900 may include a plurality of layers 8920 of a porous material wrapped around at least a portion of the electrochemical cell 8001, for example, wrapped around one or more side faces, and disposed at least partially on a top or bottom surface of the electrochemical cell 8001. The plurality of layers 8920 of the porous material may be substantially similar to the layers 7920 of the porous material and therefore, not described in further detail herein.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A method, comprising:
disposing an electrode material onto a current collector; and
disposing an electrolyte solution onto the electrode material, the electrolyte solution including an additive configured to reduce a contact angle that the electrolyte solution forms with the electrode material.

2. The method of claim 1, wherein the additive includes a micelle.

3. The method of claim 1, wherein the additive includes at least one of a fluorosurfactant, a fluorinated alcohol substituted glycol, FS-3100 (polyethylene oxide, mono(3,3,4,4,5,5,6,6,7,7,8,8,8-tridecafluorooctyl) ether), FS-10 (3,3,4,4,5,5,6,6,7,7,8,8,8-Tridecafluorooctanesulphonic acid), FS-30 (Partially Fluorinated Alcohol Substituted Glycol/Polyethylene glycol), FS-31(Partially Fluorinated Alcohol Substituted Glycol), or FS-50 (Betaine partially fluorinated surfactant).

4. The method of any one of claims 1, wherein disposing the electrolyte solution onto the electrode material is via at least one of stamping, capillary action, inkjet printing, air spray coating, or injection.

5. The method of claim 1, further comprising:
conveying the electrode material and the current collector, wherein disposing the electrolyte solution is via a stationary electrolyte dispensation apparatus.

6. The method of claim 1, further comprising:
disposing a separator on the electrode material, the separator including a coating configured to improve wettability of the electrolyte solution with the separator.

7. A method, comprising:
disposing an electrode material onto a current collector;
transferring an electrolyte solution from an electrolyte reservoir to an electrolyte nozzle via a capillary channel; and
transferring the electrolyte solution from the electrolyte nozzle to the electrode material via an orifice located at a distal end of the electrolyte nozzle.

8. The method of claim 7, wherein the electrolyte solution is transferred from the electrolyte reservoir to the capillary channel via gravity driven flow.

9. The method of claim 8, wherein the electrolyte solution at least partially fills the electrolyte reservoir to a height that is greater than a height of the electrolyte solution in the electrolyte nozzle.

10. The method of any one of claims 7, wherein the electrolyte solution includes an additive configured to reduce a contact angle the electrolyte solution forms with the electrode material.

11. The method of claim 10, wherein the additive includes at least one of a fluorosurfactant, a fluorinated alcohol substituted glycol, a perfluorinated alkyl ethoxylate, trioctyl phosphate (TOP), triethyl phosphate (TEP), or tris(2-ethylhexyl) phosphate (TEHP).

12. The method of claim 9, wherein the electrolyte nozzle forms an angle with the electrode material in a range of between about 20° and about 80°.

13. A method, comprising:
disposing an electrode material onto a current collector;
infusing a porous medium with an electrolyte solution; and
pressing the porous medium onto the electrode material, such that at least a portion of the electrolyte solution is communicated from the porous medium to the electrode material.

14. The method of claim 13, wherein:
the porous medium is disposed at a distal end of stamp, and
the porous medium is infused with the electrolyte by contacting the porous medium with the electrolyte solution disposed in an electrolyte reservoir.

15. The method of claim 13, wherein the porous medium includes at least one of cotton, linen, denim, nylon, twill, bamboo, wool, polyester, spongin, carbon cloth, polyurethane, cellulose, calcium carbonate, silica, polyethylene, or polypropylene.

16. The method of claim 13, wherein the electrolyte solution includes an additive configured to reduce a contact angle that the electrolyte solution forms with the electrode material.

17. The method of claim 16, wherein the additive includes at least one of a fluorosurfactant, a fluorinated alcohol substituted glycol, a perfluorinated alkyl ethoxylate, trioctyl phosphate (TOP), triethyl phosphate (TEP), or tris(2-ethylhexyl) phosphate (TEHP).

18. An electrode, comprising:
an electrode material disposed on a current collector;
a separator; and
a semi-solid mixture disposed between the electrode material the separator, the semi-solid mixture including a conductive material and a non-aqueous electrolyte, the semi-solid mixture configured to provide lithium ions and a solvent for consumption in the electrode material and provide a constant contact surface for wetting of the separator.

19. The electrode of claim 18, wherein the electrode material includes an anode material.

20. The electrode of claim 19, wherein the anode material includes lithium metal.

21. The electrode of claim 18, wherein the conductive material includes at least one of conductive carbon particles, conductive carbon, or hard carbon.

22. The electrode of claim 18, wherein the semi-solid mixture includes about 99.9% to about 80% by volume of the non-aqueous electrolyte and about 0.1% to 20% by volume of conductive material.

23. The electrode of claim 18, wherein the semi-solid mixture does not include an active material.

24. An electrochemical cell, comprising:
a semi-solid cathode material disposed on a cathode current collector;
an anode material disposed on an anode current collector;
a semi-solid mixture disposed on the anode material, the semi-solid mixture including a conductive material and a non-aqueous electrolyte, the semi-solid mixture configured to provide lithium ions and a solvent for consumption in the anode material; and
a separator disposed between the semi-solid mixture and the semi-solid cathode material,
wherein the semi-solid mixture is configured to provide constant contact for wetting of the separator.

25. The electrochemical cell of claim 24, wherein the non-aqueous electrolyte includes a lithium-containing salt.

26. The electrochemical cell of claims 24, wherein the semi-solid mixture includes about 99.9% to about 80% by volume of the non-aqueous electrolyte and about 0.1% to 20% by volume of conductive material.

27. An electrochemical cell assembly, comprising:
an electrochemical cell, comprising:
a semi-solid cathode material disposed on a cathode current collector,
an anode material disposed on an anode current collector, and
a separator disposed between the semi-solid mixture and the semi-solid cathode material; and
an electrolyte reservoir fluidically coupled to the electrochemical cell, the electrolyte reservoir configured to communicate an electrolyte to at least the separator.

28. The electrochemical cell assembly of claim 27, further comprising:
a housing defining an internal volume, the electrochemical cell and the electrolyte reservoir disposed in the internal volume.

29. The electrochemical cell assembly of claim 27, wherein:
the electrolyte reservoir includes a container within which the electrolyte is disposed; and
the electrochemical cell assembly further including a capillary channel fluidically coupling the electrolyte reservoir to at least the separator.

30. The electrochemical cell assembly of claim 27, wherein:
the electrolyte reservoir includes one or more layers of a porous material, the electrolyte absorbed in the porous material.

31. The electrochemical cell assembly of claim 27, wherein the electrochemical cell further includes:
a semi-solid mixture disposed between the anode material and the separator, the semi-solid mixture including a conductive material and a non-aqueous electrolyte, the semi-solid mixture configured to provide lithium ions and a solvent for consumption in the anode material.
